(19) United States
(12) Patent Application Publication
(10) Pub. No.: US 2024/0104467 A1
(43) Pub. Date: Mar. 28, 2024

(54) TECHNIQUES FOR MANAGING TASKS FOR EFFICIENT WORKFLOW MANAGEMENT

(71) Applicant: AT&T Intellectual Property I, L.P., Atlanta, GA (US)

(72) Inventors: Aritra Guha, Edison, NJ (US); Zhengyi Zhou, Chappaqua, NY (US); Jean-Francois Paiement, Palm Desert, CA (US); Eric Zavesky, Austin, TX (US); Jianxiong Dong, Pleasanton, CA (US); Wen-Ling Hsu, Bridgewater, NJ (US); Qiong Wu, Bridgewater, NJ (US); Louis Alexander, Franklin, NJ (US)

(21) Appl. No.: 17/934,382

(22) Filed: Sep. 22, 2022

(51) Int. Cl. G06Q 10/06

(52) U.S. Cl. CPC G06Q 10/0633; G06Q 10/063112; G06Q 10/06316

(57) ABSTRACT

Tasks associated with users can be managed for efficient workflow management. A task management component (TMC) can analyze, including performing artificial intelligence-based analysis on, task-related information relating to associated with a user(s), assessment information relating to assessing performance or expertise associated with a task, biometric information relating to health, diet, and activity associated with the user(s), and/or user(s) feedback information. Based on the analysis, TMC can adaptively adjust respective attributes associated with respective tasks, resulting in respective adjusted attributes associated with the respective tasks. Based on the respective adjusted attributes, TMC can determine task information and can present the task information to a device(s) associated with the user(s) to facilitate performance of the tasks. In response to detecting user fatigue or stress, TMC can adjust task attributes, including task completion due dates, to allow user recovery time, while still ensuring timely completion of tasks.

### TECHNICAL FIELD

This disclosure relates generally to electronic communications, e.g., to techniques for managing tasks for efficient workflow management.

### BACKGROUND

Communication devices (e.g., mobile phones, landline phones, electronic pads or tablets, computers, or other communication devices) can be utilized to engage in electronic communications (e.g., voice and/or data traffic) between entities associated with the communication devices. Virtual assistants (VAs) can be communication devices or can be part of or utilized by communication devices. Various services can be provided to and utilized by entities using VAs and/or communication devices in a communication network.

The above-described description is merely intended to provide a contextual overview regarding electronic communications, and is not intended to be exhaustive.

### BRIEF DESCRIPTION OF THE DRAWINGS

FIG. 1 illustrates a block diagram of an example system that can manage performance of tasks by or associated with users, including adaptively adjusting attributes associated with tasks, to facilitate desirable workflow management, in accordance with various aspects and embodiments of the disclosed subject matter.

FIG. 2 depicts a block diagram of a task management component, in accordance with various aspects and embodiments of the disclosed subject matter.

FIG. 3 presents a diagram of a non-limiting example calendar that can present information relating to a schedule of tasks and/or other desired information to a user, in accordance with various aspects and embodiments of the disclosed subject matter.

FIG. 4 depicts a diagram of a non-limiting example task management flow for desirably managing the assignment of tasks to users, the performance of tasks by users, and adaptively adjusting attributes associated with tasks, in accordance with various aspects and embodiments of the disclosed subject matter.

FIG. 5 illustrates a block diagram of an example virtual assistant, in accordance with various aspects and embodiments of the disclosed subject matter.

FIG. 6 depicts a block diagram of example communication device, in accordance with various aspects and embodiments of the disclosed subject matter.

FIG. 7 illustrates a diagram of a flow chart of an example method that can manage performance of tasks by or associated with a user to facilitate desirable workflow management, in accordance with various aspects and embodiments of the disclosed subject matter.

FIG. 8 illustrates a diagram of a flow chart of an example method that can monitor the user(s) and performance of tasks by the user(s) to manage performance of tasks by or associated with the user(s), including adaptively adjusting attributes associated with tasks, to facilitate desirable workflow management, in accordance with various aspects and embodiments of the disclosed subject matter.

FIG. 9 is a schematic block diagram illustrating a suitable operating environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Communication devices (e.g., mobile phones, landline phones, electronic pads or tablets, computers, devices in or integrated with vehicles, or other communication devices) can operate and communicate via wireline or wireless communication connections (e.g., communication links or channels) in a communication network to perform desired transfers of data (e.g., voice and/or data communications), utilize services, engage in transactions or other interactions, and/or perform other operations. Virtual assistants (VAs) (also referred to herein as virtual agents) can be communication devices or can be part of or utilized by communication devices. Various services, including services that can involve the management of tasks and performance of tasks by users, can be provided to and utilized by entities using VAs and/or communication devices in a communication network. For instance, in connection with providing a service (e.g., a service involving the management of tasks and performance of tasks by users), a communication session between communication devices, and/or between a communication device and an entity, can involve one or more human users, one or more VAs, and/or one or more other entities (e.g., software entities or components).

With regard to performing tasks, learning, or engaging in other activities, there can be diverse types of performers and learners. Some performers or learners may work best with multitasking, and some performers or learners may work best sequentially working on tasks. Also, often while performing tasks across the day, a person may not have full functionality for all tasks. For instance, some users often may have better functionality for working on certain tasks (e.g., more difficult, detail oriented, or intensive tasks) in the morning, while other users often may not have good functionality for working on those certain tasks in the morning, but often may have better functionality for working on such tasks in the afternoon. Further, different people can have different levels of education, experience, or expertise with regard to different types of tasks or subjects.

Also, with regard to arrangement and performance of tasks, it can be desirable to be mindful of deadlines to perform individual tasks and an overall task comprised of a group of individual tasks (e.g., sub-tasks), and health conditions associated with persons who may be performing the tasks. Furthermore, when multiple people are involved in a task, such as a group meeting or collaborative performance of a task (e.g., an overall or large task comprising various sub-tasks to be performed by different users of the group or team), this can create additional constraints as, for example, different abilities of different users to perform various types of sub-tasks have to be accommodated, different schedules and availabilities of different users to work on sub-tasks have to be accommodated, dependency of the performance of one sub-task on the performance of another sub-task have to be accommodated, and/or sequencing of sub-tasks have to be managed, and/or there can be other constraints relating to the task.

It can be desirable to overcome these and other deficiencies or inefficiencies associated with existing techniques or procedures associated with managing the performance of tasks by users in individual situations and group situations.

To that end, techniques for managing performance of tasks by or associated with users to facilitate desirable (e.g., favorable, efficient, improved, or optimal) workflow management are presented. A task management component (TMC) can analyze task-related information relating to associated with a user(s), assessment information relating to assessing performance or expertise (e.g., user expertise) associated with a task, biometric information relating to health, diet, and/or activity associated with the user(s), feedback information relating to tasks, and/or relating to health, diet, and/or activity associated with the user(s), and/or other information that can be pertinent to management of the performance of tasks and workflow management. In some embodiments, as part of the analysis, the TMC can perform an artificial intelligence (AI)-based analysis on the task-related information, the assessment information, the biometric information, the feedback information, and/or the other information. The AI-based analysis can comprise utilizing or applying AI, machine learning (ML), models, neural networks, functions, and/or other AI-based techniques and algorithms on such information.

Based at least in part on the results of the analysis, the TMC can adaptively adjust (e.g., modify, alter, or change) respective attributes (e.g., properties, elements, or characteristics) associated with respective tasks associated with respective users, which can thereby result in respective adjusted attributes associated with the respective tasks. Based at least in part on the respective adjusted attributes, the TMC can determine task information relating to the respective tasks (e.g., task and work schedule information), including the respective adjusted attributes associated with the respective tasks. The TMC can present (e.g., communicate or display) the task information to a communication device(s) or VA(s) associated with the user(s) to facilitate performance of the tasks by the user(s).

In accordance with various embodiments, the TMC can continue to monitor users and tasks, and as new task-related information, feedback information, and/or other information relating to the users and tasks is received and analyzed by the TMC, the TMC can adaptively adjust respective attributes associated with the respective tasks associated with the respective users to account for and reflect the new information. The TMC can present respective updated (e.g., adaptively adjusted) task information to the respective users via their respective communication devices or VAs to facilitate performance of the respective tasks by the respective users.

In certain embodiments, the TMC can determine whether a user is experiencing an undesirably high level of fatigue or stress (e.g., experiencing a level of stress or fatigue that satisfies (e.g., meets or exceeds) a defined threshold level of fatigue or stress), based at least in part on the results of analyzing biometric information associated with the user and/or feedback information received from the user or another data source. If the TMC detects that the user is experiencing an undesirably high level of fatigue or stress, the TMC can adjust task attributes, including task completion due dates, to allow the user to have suitable recovery time to facilitate reducing the user's fatigue or stress level, while still ensuring, or at least endeavoring to maintain, the timely completion of tasks.

The techniques, TMC, communication devices, VAs, and associated applications described herein can provide a number of advantages and benefits relating to managing tasks and users in the performance of tasks, adaptively adjusting attributes associated with tasks in response to changes of context associated with users or tasks, and managing the performance of tasks by users in individual settings or group (e.g., collaborative) settings, over existing techniques relating to managing tasks and the performance of tasks by users, such as described herein.

These and other aspects and embodiments of the disclosed subject matter will now be described with respect to the drawings.

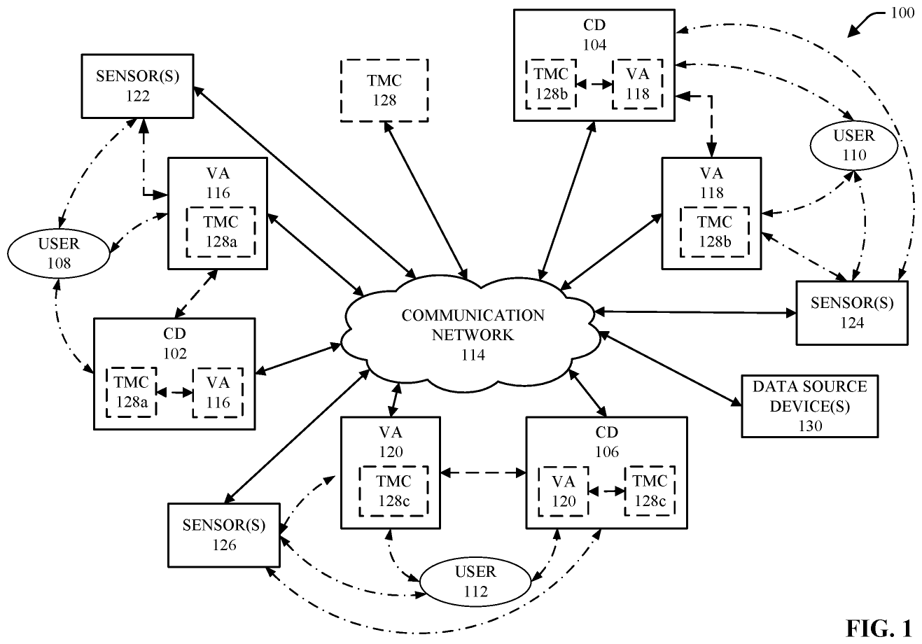

Referring now to the drawings, FIG. 1 illustrates a block diagram of an example system 100 that can manage performance of tasks by or associated with users, including adaptively adjusting attributes associated with tasks, to facilitate desirable (e.g., favorable, efficient, improved, or optimal) workflow management, in accordance with various aspects and embodiments of the disclosed subject matter. The system 100 can comprise a desired number of communication devices, including communication device (CD) 102, communication device 104, and/or communication device 106. The communication devices can be associated with various entities. For instance, communication device 102 can be associated with user 108, communication device 104 can be associated with user 110, and communication device 106 can be associated with user 112. A communication device (e.g., 102, 104, or 106) can be, for example, a mobile and/or wireless communication device, such as a mobile phone, a landline or wireline phone, a device comprising a virtual assistant (VA), a computer, a medical, health, or biometric device or sensor, an electronic notebook, an electronic pad or tablet, an electronic gaming device, a personal digital assistant (PDA), electronic bodywear (e.g., electronic or smart glasses, electronic or smart watch), a set-top box, an Internet protocol (IP) television (IPTV), an Internet-of-Things (IoT) device, a device associated or integrated with a vehicle, or other type of communication device that can operate and communicate in a communication network environment (e.g., an environment associated with a communication network 114).

The system 100 also can comprise a desired number of VAs, such as VA 116, VA 118, and/or VA 120, that can be associated with various entities, such as the user 108, user 110, and/or user 112, respectively. Each of the VAs (e.g., 116, 118, and/or 120) can interact with a user(s) (e.g., 108, 110, and/or 112) and can perform various tasks for or on behalf of the user(s) that can be associated with the VA.

In some embodiments, a VA (e.g., 116, 118, and/or 120) can be included in, integrated with, or implemented via a device (e.g., a VA device), which can be a type of communication device. In other embodiments, the VA can be included in, integrated with, or implemented via a communication device (e.g., a VA application installed on or accessed via a communication device, such as communication device 102, communication device 104, or communication device 106) associated with a user. In accordance with various embodiments, the user (e.g., 108, 110, or 112) can interact directly with the VA (e.g., 102, 104, or 106) and/or device associated therewith, and/or the user can interact with the VA via the communication device (e.g., 114, 116, or 118) associated with the user, wherein the VA or device associated therewith can communicate with the communication device via a direct communication connection (e.g., audio or visual communication over the air, wireless communication connection, or wireline communication connection) or via a communication network 114.

With regard to the communication network 114, in some embodiments, the communication network 114 can comprise a core network (e.g., a mobility core network) that can comprise one or more radio access networks (RANs) (not shown) that can comprise or be associated with a set of base stations (e.g., access points (APs)) (not shown) that can serve communication devices (e.g., communication devices 102, 104, and/or 106; VAs 116, 118, and/or 120; and/or other devices) located in respective coverage areas served by respective base stations in the communication network 114. In some embodiments, the RAN(s) can be a cloud-RAN (C-RAN) that can be located in or associated with a cloud computing environment, comprising various cloud network components of the communication network 114. The respective base stations can be associated with one or more sectors (not shown), wherein respective sectors can comprise respective cells. The cells can have respective coverage areas that can form the coverage area covered by the one or more sectors. One or more of the respective communication devices (e.g., communication devices 102, 104, and/or 106; VAs 116, 118, and/or 120; and/or other devices) can be communicatively connected to the communication network 114 via respective wireless communication connections with one or more of the respective cells.

In certain embodiments, the communication network 114 can comprise a packet-based communication network (e.g., IP packet-based communication network) that can facilitate wireline or wireless communication of data (e.g., data packets) between communication devices associated with the communication network 114 (e.g., the core network or packet-based communication network). The packet-based communication network can be associated with (e.g., communicatively connected to) the core network. One or more of the respective communication devices (e.g., communication devices 102, 104, and/or 106; VAs 116, 118, and/or 120; and/or other devices) can be communicatively connected to the communication network 114 via respective wireline or wireless communication connections.

It is to be appreciated and understood that, while the disclosed subject matter is typically described with regard to VAs, another type of software-based entity (e.g., software-based application or component) can be employed to perform the functions of the VAs, as described herein. It is to be appreciated and understood that, while some aspects of the disclosed subject matter are described where the user (e.g., 108, 110, or 112) can use the communication device (e.g., 102, 104, or 106) for communication (e.g., transmission, reception) of information (e.g., interaction-related and/or event-related information) to or from another device (e.g., another communication device, a VA, or other type of device), in certain aspects of the disclosed subject matter, the user can communicate information using, and can receive information from, the VA (e.g., 116, 118, or 120) (or associated device) (e.g., by speaking into an interface of or associated with the VA (or associated device), by receiving (e.g., hearing, viewing, or perceiving) information presented via an interface of or associated with the VA (or associated device)). For example, a VA (e.g., 116, 118, or 120) can be associated with (e.g., integrated with, attached to) a vehicle of the user (e.g., 108, 110, or 112), wherein the user can use (e.g., communicate using) the VA with regard to one or more services that can be provided using or facilitated by the VA. It further is to be appreciated and understood that a VA (e.g., 116, 118, or 120) exist on (e.g., be integrated with), accessed via, or otherwise associated with multiple devices (e.g., user 108 can access the VA 116 via a VA device, communication device 102, or another device).

A VA (e.g., 116, 118, or 120) can be a domain-specific VA or can be a generalized (or at least a more generalized) VA. For example, a domain-specific VA can be created and utilized to provide services or products for one or a relatively small subset of domains (e.g., a VA that provides or facilitates providing medical-related services or products; a VA that provides or facilitates providing food-related services or products; a VA that provides or facilitates providing video and/or audio content-related services or products; a VA that provides or facilitates providing sports-related services or products; or other type of domain-specific VA). As another example, a generalized (or a more generalized) VA can be created and utilized to provide services or products for all domains or at least a relatively larger subset of domains. The disclosed subject matter can enable the use of VAs to act as intermediaries and/or navigators for and on behalf of users and/or other entities, for example, with regard to interactions (e.g., medical or health-related interactions).

The system 100 also can comprise various sensors, including sensor(s) 122, sensor(s) 124, and/or sensor(s) 126, that can sense or measure various conditions. For instance, respective sensors (e.g., 122, 124, and/or 126) can be biometric sensors that can sense or measure biometric conditions of or associated with users (e.g., 108, 110, and/or 112), environmental sensors that can sense or measure environmental conditions associated with users, or other types of sensors. A sensor can be or can comprise a camera(s) or a microphone(s). A sensor can be a standalone device or can be part of another device (e.g., can be part of a communication device). Biometric conditions can comprise, for example, heart rate, heart rhythm, heart electrical activity (e.g., electrocardiogram (ECG)), blood pressure, blood sugar level, blood oxygen saturation, body temperature, respiration rate, bodily movement (e.g., steps taken by user), skin perspiration, heat flux, calories burned, weight, alcohol level, sleep patterns, or other desired biometric conditions associated with a user. In some embodiments, in addition to biometric sensors that can sense or measure the aforementioned biometric conditions, other biometric sensors can include fingerprint sensors, facial recognition sensors, iris recognition sensors, speech recognition sensors, hand geometry sensors, or other type of sensor that can be utilized for biometric identification of users or other entities. Environmental conditions can comprise, for example, air or ambient temperature, humidity, wind speed, amount or type of precipitation, amount or type of air pollution, amount or type of allergens, barometric pressure, altitude, ultraviolet (UV) index, or other desired environmental conditions.

In accordance with various embodiments, the system 100 can include a task management component(s) (TMC) 128 that can manage (e.g., automatically and dynamically manage, in real time or near real time) performance of tasks by or associated with users (e.g., 108, 110, and/or 112) to facilitate desirable (e.g., favorable, efficient, improved, or optimal) workflow management, in accordance with defined task management criteria. The TMC 128 can be a stand-alone unit, can be part of another device or component, or can be distributed among various devices and components. In some embodiments, the TMC 128 can be associated with (e.g., communicatively connected to the communication network 114 to enable the TMC 128 to be associated with (e.g., in communication with) the users (e.g., 108, 110, and/or 112), communication devices (e.g., 102, 104, and/or 106), and/or VAs (e.g., 116, 118, and/or 120). In certain embodiments, respective communication devices (e.g., communication devices 102, 104, and/or 106; and/or VAs 116, 118, and/or 120) can comprise respective TMCs, such as TMC 128a, TMC 128b, and/or TMC 128c (e.g., a task management application). In still other embodiments, the system 100 can comprise TMC 128 associated with the communication network 114, and respective TMCs (e.g., 128a, 128b, and/or 128c) that can be part of communication devices, wherein the TMC 128 associated with the communication network 114 can be a centralized TMC that can communicate or interact with, and/or can manage, the TMCs (e.g., 128a, 128b, and/or 128c) of the communication devices that can act as local or mobile TMCs or task management agents with respect to the centralized TMC 128. That is, a TMC can be included in, integrated with, implemented via, or otherwise associated with the communication devices.

The TMC 128 and the techniques and functions implemented by the TMC 128 and other components and devices disclosed herein can allow for interactive planning and time-allotment for tasks for performance by users (e.g., users 108, 110, and/or 112) depending in part on the level of engagement desired (e.g., wanted or required) of users with respect to the tasks, impending deadlines for completing tasks, health conditions (e.g., physical and/or mental health conditions) of users, and/or other factors. The TMC 128 can incorporate biometric components (e.g., biometric information associated with the users) to obtain holistic, sustainable view of performance of tasks by the users and conditions associated with the users.

The TMC 128 and the techniques and functions implemented by the TMC 128 and other components and devices disclosed herein also can adaptively adjust (e.g., readjust) goals (and tasks) as trade-offs between capacity (e.g., capacity of users to perform tasks, and/or capacity and resources of equipment utilized by the users to perform tasks) and goal definition by interactive connection to the user(s). For instance, the TMC 128 can allow a user (e.g., user 108) to preset tasks and priorities (e.g., in the form of deadlines or personal preference) for completing the tasks. A VA (e.g., VA 116) can nudge or try to motivate the user to perform certain tasks when they are close to the task deadlines for completion decided by an adaptive rank-based recommender function of the TMC 128. The TMC 128 also can measure the effectiveness of users (e.g., users 108, 110, and/or 112) in performing tasks obtaining information from and across users (e.g., obtaining information relating to time distribution of a user reaching certain expertise level in performing a task or sub-task, such as described herein). The TMC 128 also can determine and suggest (e.g., recommend) new tasks (e.g., work tasks, or personal or leisure tasks) by crowdsourcing to obtain information from various users to enable efficient task completions by users, where, for example, the TMC 128 can account for and accommodate (or at least try to accommodate) the amount of sleep a user should have in order to be able to achieve desirable (e.g., good, enhanced, or optimal) performance of tasks and improve productivity of users by accounting for and accommodating (or at least trying to accommodate) the personal happiness goals of users.

In some embodiments, the TMC 128 can recommend or suggest that a user (e.g., user 108) refine a task list of the user (e.g., by adding tasks to or deleting tasks from the task list) based at least in part on historical task completions and productivities of the user (e.g., user 108) and/or other users (e.g., users 110 and/or 112) across various tasks. For instance, the TMC 128 can allow a user variance get around and exit the task management application program (e.g., application being managed by the TMC 128 and utilized by users via their communication devices and VAs) as well as provide motivational tracking of the user to try to keep the user engaged and/or can suggest alternate content or consumption environment to the user.

In certain embodiments, for group-based tasks, the TMC 128 can navigate multilevel constraints for management of work, including performance of tasks, by users to ensure desirable (e.g., smooth, suitable, efficient, improved, or optimal) collaborative workflow by the users in or associated with the group. For instance, with regard to the multilevel constraints, when determining respective assignments of respective tasks to respective users (e.g., users 108, 110, and/or 112) and respective attributes associated with the respective tasks, the TMC 128 can account and/or accommodate for different abilities of different users to perform various types of sub-tasks, different schedules and availabilities of different users to work on sub-tasks, dependency of the performance of one sub-task on the performance of another sub-task (e.g., a second sub-task is not able to be performed by a second user until a first sub-task has been performed and completed by a first user), and/or sequencing of sub-tasks, and/or other constraints relating to the tasks, workflow, and overall goal or project. That is, the TMC 128 can determine the respective assignments of the respective tasks to the respective users (e.g., users 108, 110, and/or 112) and the respective attributes associated with the respective tasks based at least in part on one or more of those constraints, in accordance with the defined task management criteria. For instance, with regard to sub-tasks of an overall task that is to be performed by a group of users, the TMC 128 can determine and coordinate assignment and scheduling of respective sub-tasks to respective users based at least in part on respective expertise levels of the respective users with regard to the respective sub-tasks, respective roles (e.g., work positions, such as assembly line worker, mechanic, maintenance person, technician, analyst, supervisor, manager, or other type of work position) of the respective users in relation to the respective sub-tasks, respective due dates or priority levels of the respective sub-tasks, respective dependencies of sub-tasks on other sub-tasks, and/or other factors. The TMC 128 also can monitor performance of the respective sub-tasks by the respective users and provide updates regarding respective performance of respective sub-tasks by the respective users to all other users associated with the overall task. The TMC 128 also can enhance or optimize the effectiveness of a group goal for a group of users, for instance, by adaptively adjusting attributes associated with individual tasks of users to incorporate group-based goals while maintaining desirable (e.g., suitable, enhanced, balanced, and/or physically and mentally healthy) work schedules for users.

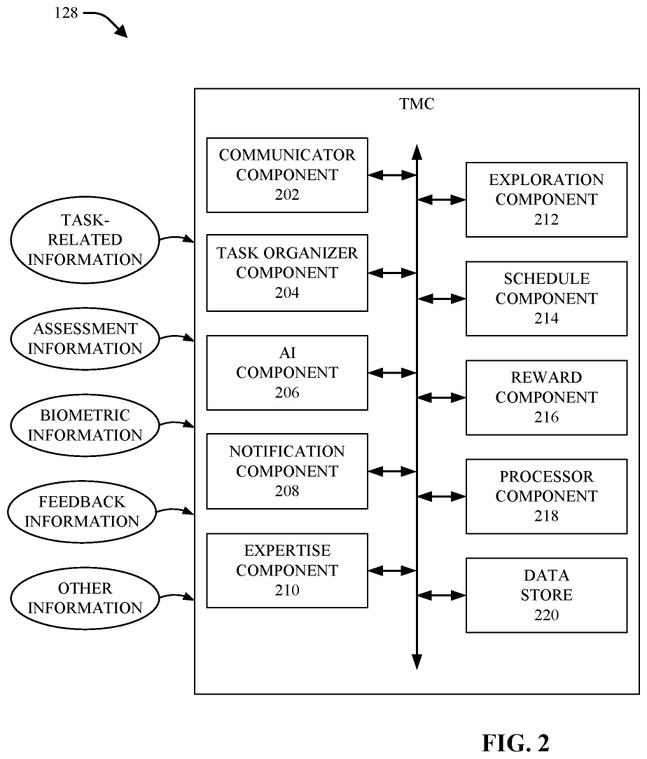

Referring to FIG. 2 (along with FIG. 1), FIG. 2 depicts a block diagram of a TMC 128 (which can be or can be applicable to TMC 128, 128a, 128b, or TMC 128c, but generally referred to as TMC 128), in accordance with various aspects and embodiments of the disclosed subject matter. The TMC 128 and/or one or more communication devices (e.g., communication devices 102, 104, and/or 106; and/or VAs 116, 118, and/or 120) can receive various types of data from various data sources, including users (e.g., users 108, 110, and/or 112), sensors (e.g., sensors 122, 124, and/or 126), data source device 130, and/or other data sources. The TMC 128 can comprise a communicator component 202 that can enable the TMC 128 to receive or communicate information from or to other components or devices (e.g., VAs, communication devices, data source device, network equipment, sensors, or other devices), users, and/or other entities. In some embodiments, the TMC 128 and/or one or more communication devices (e.g., communication devices 102, 104, and/or 106; and/or VAs 116, 118, and/or 120) can receive task-related information relating to tasks to be performed by one or more users (e.g., users 108, 110, and/or 112) from the one or more users, an entity (e.g., employer of, or contractor employing or using, the one or more users) via a communication device(s) associated with the entity, the one or more users, and/or another data source. The task-related information can comprise information regarding or relating to, for example, a type of task, sub-tasks of a task, a level of user expertise desired with regard to a task, a location(s) where the task is to be performed, a due date(s) for performance and/or completion of the task or its sub-task(s), instructions for performance of a task, equipment desired to be utilized to perform a task, and/or other desired task-related information.

In certain embodiments, prior to, during, or in connection with the performance of one or more tasks, the TMC 128 and/or one or more communication devices (e.g., communication devices 102, 104, and/or 106; and/or VAs 116, 118, and/or 120) can receive feedback information from the entity, the one or more users (e.g., users 108, 110, and/or 112), and/or another data source. The feedback information can comprise information relating to or regarding, for example, work-based objectives (e.g., work performance, work advancement, work compensation, or other work-based objectives or goals) of the user or employer of the user, personal objectives (e.g., career, educational, financial, familial, hobby, physical health, mental health, or other personal objectives or goals) of the user, priority levels of tasks, amount of time expected to be utilized (e.g., wanted or required) to perform and complete a task, a level of expertise of a user with regard to performance of a task, a level of expertise and/or an amount of experience of a user with regard to performing the task or in a field (e.g., an employment or technical field) associated with the task, employment history of a user, educational history of the user, health-related, medical-related, and/or diet-related information of a user, location of a user (e.g., location where user lives, region where user is available to work), equipment (e.g., computer-related and/or communication device-related equipment, tools, or other equipment) available to a user for use in performing tasks, goal information relating to a goal(s) of a user with regard to a task, activity, employment, career, hobby, health, and/or life, personal data of a user (e.g., name, age, gender, religion, race, ethnicity, familial status, education, family medical history, income or wealth, or other personal data or personal characteristics of or associated with the user), demographic information relating to demographic characteristics associated with a user (e.g., residential characteristics (e.g., location or region of the residence, type of residence), age characteristics (e.g., age or age bracket), employment characteristics (e.g., type of employment), education characteristics (e.g., highest level of education, school or college attended), gender characteristics, religious characteristics, race characteristics, ethnicity characteristics, familial characteristics, income or wealth characteristics, or other demographic data or demographic characteristics associated with the user), and/or other desired feedback information. The feedback information also can comprise assessment of a user's performance of a previous task or current performance of a task by the user (e.g., for a task that the user has started working on, but has not yet completed), wherein the assessment can be made by the entity (e.g., employer or contractor, supervisor or overseer), the user, another entity, and/or a device or component. The feedback information also can include biometric feedback information (e.g., heart rate, heart rhythm, heart electrical activity, blood pressure, blood sugar level, blood oxygen saturation, body temperature, eyeball movement, focus of attention, diet, stress level, or other desired biometric conditions or feedback, such as described herein) that can be received from a user (e.g., users 108, 110, and/or 112), measured by and/or received from the sensors (e.g., sensors 122, 124, and/or 126), and/or measured by and/or received from communication devices (e.g., communication devices 102, 104, and/or 106; and/or VAs 116, 118, and/or 120) associated with the user. The feedback information also can comprise environmental feedback information relating to an environment(s) (e.g., air or ambient temperature, humidity, wind speed, amount or type of precipitation, amount or type of air pollution, amount or type of allergens, barometric pressure, altitude, UV index, or other desired environmental conditions associated with an environment(s), such as described herein) where a user is and/or where a user can perform a task.

In certain embodiments, the TMC 128 can obtain or collect information (e.g., task-related information, feedback information, or other information) from the one or more users (e.g., users 108, 110, and/or 112) by communicating queries (e.g., personalized questions) to the one or more users (or other entity) via the communication devices (e.g., communication devices 102, 104, and/or 106; and/or VAs 116, 118, and/or 120) associated with the one or more users (or other entity). The TMC 128 also can continue to monitor the one or more users (e.g., users 108, 110, and/or 112) as they perform their respective tasks, and can continue to receive additional information (e.g., additional task-related information, feedback information, or other information) from the one or more users, the sensors (e.g., sensors 122, 124, and/or 126), the communication devices (e.g., communication devices 102, 104, and/or 106; and/or VAs 116, 118, and/or 120), one or more entities, and/or other data sources.

The TMC 128 can comprise a task organizer component 204 that can analyze the task-related information, the feedback information, and/or other desired information to facilitate determining whether to adjust (e.g., adaptively adjust or modify) respective attributes associated with respective tasks associated with the user(s) (e.g., users 108, 110, and/or 112), in accordance with the defined task management criteria. In some embodiments, the TMC 128 also can comprise an AI component 206 that work in conjunction with the task organizer component 204 to facilitate making determinations relating to the organization of tasks associated with users. As part of the analysis of the task-related information, the feedback information, and/or other desired information by the task organizer component 204, the AI component 206 can perform an analysis (e.g., an AI-based analysis) on the task-related information, the feedback information, and/or other desired information utilizing (e.g., applying) one or more AI-based techniques, functions, or algorithms, to enable the AI component 206 to learn various desired task and/or user related actions (e.g., actions that can be performed by the TMC 128) or enhancements from the task-related information, the feedback information, and/or other desired information (e.g., learn respective data patterns in such data; learn about respective task performance of the one or more users; learn level of expertise or level of experience of a user with respect to a task or a field associated with the task; learn priority levels associated with tasks or an associated project; learn adjustments that can be made to attributes associated with tasks to facilitate enhanced performance of tasks by the one or more users and/or to facilitate enhancing lifestyles, stress levels, and/or goals of the one or more users; learn new, leisure, and/or hobby-related tasks for a user to perform; and/or learn other characteristics and features associated with the tasks or users), such as described herein.

In some embodiments, based at least in part on the results of the analysis by the task organizer component 204 and/or AI component 206, the task organizer component 204 can determine (e.g., automatically determine, in real time or near real time) respective task performance of the one or more users (e.g., users 108, 110, and/or 112), respective levels of expertise or respective levels of experience of the respective users with respect to a task or a field associated with the task, respective priority levels associated with respective tasks or associated project, respective fatigue or stress levels of the respective users, respective health, medical, and/or fitness or diet assessments (e.g., food or calorie intake, sleep amount or quality, amount or type of physical or mental exercises) or issues associated with the respective users, respective schedules (e.g., personal or working schedules) associated with the respective users, respective assignments of respective tasks to respective users, respective adjustments that can be made to respective attributes associated with the respective tasks, respective new, leisure, and/or hobby-related tasks that can be proposed or presented to the respective users, attributes associated with tasks, attributes associated users, and/or other desired task or user related actions or enhancements, in accordance with the defined task management criteria.

The respective attributes associated with the respective tasks can comprise or relate to, for example, an order, a sequence, or a schedule of the performance of the respective tasks; an amount of time allocated to perform a task; a priority level associated with a task; a determination regarding an amount of progress that has been made towards completion of a task; instructions that can indicate how a task is to be performed; a reminder, notification, or motivation message relating to a task; calendar information relating to a task that can be contained or presented in an electronic calendar associated with a user; a reward that can be presented to a user(s) in connection with completion of a task or group of tasks; and/or other desired attributes associated with a task, including those attributes as described herein.

Based at least in part on the results of the analysis by the task organizer component 204 and/or AI component 206, including the determinations made by the task organizer component 204 based at least in part on such analysis results, the task organizer component 204 can adaptively adjust (e.g., in real time or near real time) the respective attributes associated with the respective tasks, in accordance with the defined task management criteria. For instance, based at least in part on the results of the analysis by the task organizer component 204 and/or AI component 206, the task organizer component 204 can adaptively adjust (e.g., modify, change, reorganize, or reprioritize) the order, sequence, or schedule of the performance of the respective tasks or sub-tasks of a task; adaptively adjust the amount of time allocated to perform a task; adaptively adjust a priority level associated with a task (e.g., reprioritize a task); adaptively adjust a determination regarding an amount of progress that has been made towards completion of a task; adaptively adjust instructions that indicate how a task is to be performed; adaptively adjust a reminder, notification, or motivation message relating to a task; adaptively adjust calendar information relating to a task in the electronic calendar; adaptively adjust a reward that is to be presented in connection with completion of a task or group of tasks; or adaptively adjust another attribute associated with a task.

For example, based at least in part on the results of analysis of the task-related information, the feedback information, and/or other desired information by the task organizer component 204 and/or AI component 206, the task organizer component 204 can determine that, on weekday mornings, the user 108 prefers to read news online for approximately 15 minutes before beginning to do significant work tasks for the work day, and usually can perform work tasks better when the user 108 has that time to read news; can determine that the user 108 has significant experience and expertise with regard to certain work tasks and typically is able to perform these certain tasks in a relatively shorter amount of time, as compared to other workers; and can determine that the user 108 prefers to perform more challenging work tasks in the later part of the morning or mid-afternoon (but not right after lunch), and less challenging work tasks in the earlier part of the work morning, just after lunch, or towards the end of the work day, and usually can perform work tasks better when more challenging work tasks and less challenging work tasks are respectively scheduled during those respective times of the work day. Based at least in part on such determinations, the task organizer component 204 can assign a subset of work tasks, including the certain work tasks, to the user 108 to perform over a particular time period (e.g., some tasks to perform that day, other tasks to be performed within the next week) such that the work tasks can be performed by the user 108 by or before their respective due dates and/or in accordance with their respective priority levels; can adjust attributes associated with the work tasks to organize or schedule the performance of the work tasks such that there is a short period of time (e.g., approximately 15 minutes) each work morning for the user 108 to read news online; can adjust attributes associated with the work tasks to allocate relatively shorter amounts of time for the user 108 to perform the certain tasks, as compared to the relatively longer amounts of time that would otherwise be allocated for such work tasks if and when performed by other users who have less experience or expertise than the user 108 with respect to those certain work tasks; and can adjust attributes associated with the work tasks to schedule the more challenging tasks to be performed in the later part of the morning and/or mid-afternoon of the work data and the relatively less challenging task to be performed in the earlier part of the work morning, just after lunch, and/or towards the end of the work day; the task organizer component 204 determining that such assignment, organizing, and scheduling of the work tasks to the user 108 can result in an overall desired (e.g., favorable, suitable, enhanced, or optimal) performance of the work tasks by the user 108 and/or an overall desired performance of all of the work tasks by all of the users (e.g., users 108, 110, and/or 112, and/or other users), in accordance with the defined task management criteria.

While the user 108 may prefer to read news online for approximately 15 minutes before beginning to do significant work tasks for the work day, as another example, the user 110 may not really be that interested in reading news online, but rather can prefer to play games online (e.g., online electronic gaming) for a short time (e.g., 15 to 30 minutes) before beginning to do significant work tasks for the work day. Based at least in part on such information relating to the interest of the user 110 in playing games online and/or information relating to how well the user 110 performs tasks or how the user feels when the user has such time to play games online before work as compared when the user 110 does not play games online before work, the TMC 128 (e.g., task organizer component 204 and/or AI component 206) may determine that such short time for the user 110 to play games online before beginning significant work for the day is to be included in the schedule of the user 110, particularly if the TMC 128 determines that the user 110 performs tasks better when the user 110 plays games online beforehand, the user 110 tends to have a lower stress or fatigue level, or is more alert (e.g., better focus of attention), when performing tasks when the user 110 plays games online beforehand, and/or the user 110 tends to be in a better mood (e.g., happier) when the user 110 plays games online beforehand.

As still another example, based at least in part on analysis of information relating to the user 112, the TMC 128 may determine that the user 112 can prefer to listen to certain music while performing tasks. From that knowledge, the TMC 128 (e.g., task organizer component 204 and/or AI component 206) may determine that allowing the user 112 to “multitask” by listening to certain music while the user 112 is performing tasks can be desirable and can include the user 112 listening, or being able to listen, to such music as a “task” while doing tasks (e.g., work tasks) in the schedule of the user 112, particularly if the TMC 128 determines that the user 112 performs tasks better when the user 112 “multitasks” by also listening to music while working, the user 112 tends to have a lower stress or fatigue level, or is more alert, when performing tasks when the user 112 “multitasks” by also listening to music while working, and/or the user 112 tends to be in a better mood (e.g., happier) when the user 112 “multitasks” by also listening to music while working.

The TMC 128 can continue to monitor the performance of tasks and/or other activities by the user 108 and/or the other users (e.g., users 110 and/or 112, and/or other users) and feedback relating to the users and/or tasks, and can collect (e.g., via the communicator component 202) additional task-related information, feedback information (e.g., biometric feedback information, verbal or written feedback information, and/or other feedback information), and/or other desired information relating to the users and/or tasks. The task organizer component 204 and/or the AI component 206 can perform an analysis (e.g., AI-based analysis) on the additional task-related information, feedback information, and/or other desired information, and/or the previous (e.g., historical) task-related information, feedback information, and/or other desired information relating to the users (e.g., users 108, 110, and/or 112, and/or other users) and/or tasks.

In an example scenario, the additional task-related information can indicate that the user 108 has been performing assigned tasks in accordance with the task schedule and in accordance with the respective priority levels of the respective tasks, and the feedback information can indicate that the user 108 is experiencing a higher than normal amount of stress or fatigue during a particular work afternoon. For instance, the TMC 128 can perform emotion, stress, or fatigue detection to facilitate determining whether the user 108 is experiencing an undesirably high amount of stress or fatigue, wherein analysis of visual images captured by a camera of a communication device (e.g., 102) or other biometric information captured by another sensor (e.g., heart rate or blood pressure sensor, or electronic or smart watch) associated with the user 108 can indicate to the TMC 128 that the user 108 is experiencing a higher than normal amount of stress or fatigue during a particular work afternoon. Based at least in part on the results of this subsequent analysis of additional information and/or previous information, the task organizer component 204 can determine that the user 108 is experiencing a higher than normal amount of stress or fatigue during a particular work afternoon (e.g., based at least in part on biometric feedback information, such as blood pressure, heart rate, focus of attention, or other biometric feedback information, associated with the user 108), can determine that the user has been performing the assigned tasks in accordance with the task schedule and the respective priority levels of the respective tasks (although the user 108 recently has been slowing down on performance of tasks due in part to the stress or fatigue), and can further determine that the remaining tasks the user 108 has yet to perform can still be performed by the user 108 by their respective due dates (e.g., hard deadline due dates or other type of due dates) and in accordance with the respective priority levels of the respective remaining tasks even if the user 108 were to end the work day an hour early that afternoon. In some embodiments, based at least in part on such information analysis, the TMC 128 (e.g., the task organizer component 204 and/or AI component 206) can learn, determine, or infer that there is a correlation or causation between the user 108 performing, or at least trying to perform, tasks that day and the higher than normal amount of stress or fatigue the user 108 is experiencing.

Based at least in part on such determinations, the task organizer component 204 can adaptively adjust attributes associated with the work tasks of the work and task schedule of the user 108, or recommend that the attributes associated with the work tasks of the user 108 be adaptively adjusted, to allocate the last hour of this work day as relaxation (e.g., leisure) or rest time for the user 108 and reorganize the remaining tasks assigned to the user 108, including any remaining task(s) that had been scheduled for that last hour of the afternoon, to accommodate the user 108 ending work an hour early that afternoon, while still scheduling the remaining tasks to be performed in accordance with their respective due dates and/or respective priority levels, in accordance with the defined task management criteria. In some example instances, the task attribute adjustment may involve a re-allocation of respective amounts of time to perform the respective remaining tasks (e.g., the task organizer component 204 may shorten the amounts of time to perform some of the remaining tasks, in accordance with the experience or expertise of the user 108 and/or historical performance times of the user 108 performing those work tasks or similar work tasks), or adjustment of the work schedule of the user 108 to add part or all of that hour of work to another work day or an off day. In certain embodiments, if the TMC 128 determines that the stress, fatigue, or other health issues of the user 108 are significant or severe enough to potentially warrant professional or medical attention the TMC 128 also may recommend to the user 108 that the user 108 consider seeking healthcare (e.g., physical or mental healthcare) from a healthcare professional to help address the stress, fatigue, or other health issues.

If the task organizer component 204 has made such a recommendation to adaptively adjust attributes associated with remaining tasks of the work and task schedule of the user 108, the task organizer component 204, employing a notification component 208 and communicator component 202, can generate a notification message and communicate the notification message to the user 108, the communication device 102, and/or the VA 116, wherein the notification message can include the recommendation to adaptively adjust attributes associated with remaining tasks of the work and task schedule of the user 108 and have the user 108 end work an hour early that day to provide the user 108 some relaxation or rest time to recover from the fatigue the user 108 is experiencing, as detected by the task organizer component 204. The user 108 can consider or evaluate the recommended task and schedule adjustment, and can accept the recommended task and schedule adjustment, or can negotiate a different task and schedule adjustment with the task organizer component 204 (e.g., the user 108 can request that a different adjustment be made to the attributes associated with the tasks of the work and task schedule and can negotiate with the task organizer component 204 to determine an acceptable change to the attributes associated with the tasks of the work and task schedule), or can override the recommendation (e.g., the user 108 can decide to continue working for the last hour of that work day, or the user 108 can make a desired change to the work and task schedule).

If the user 108 has accepted the recommended task and schedule adjustment, the task organizer component 204 can receive such acceptance indication (e.g., a verbal or written acceptance message, or a selection of a control or button indicating acceptable) from the user 108 via an interface(s) of the TMC 128, communication device 102, or VA 116, and the task organizer component 204 can perform the adjustment of the attributes associated with the tasks of the work and task schedule of the user 108, in accordance with the recommended task and schedule adjustment. If, instead, the user 108 has decided to override the recommended task and schedule adjustment to have the work and task schedule remain the same, the task organizer component 204 can receive such override indication (e.g., a verbal or written override or decline message, or a selection of a control or button indicating overriding or declining the recommendation) from the user 108 via an interface(s) of the TMC 128, communication device 102, or VA 116, and the task organizer component 204 can maintain the current work and task schedule of the user 108 without adjustment of task attributes. If, instead, the user 108 has decided to override the recommended task and schedule adjustment to have the attributes associated with the tasks changed in a different way, as desired by the user 108, the task organizer component 204 can receive such override indication from the user 108 via an interface(s) of the TMC 128, communication device 102, or VA 116, and the task organizer component 204 can adjust the attributes associated with the tasks of the work and task schedule of the user 108, in accordance with the change desired by the user 108, provided that the user 108 has the authority to change the user's work and task schedule in such a way (or can decline such a change, if the user 108 does not have the authority to make such a change). If, instead, the user 108 has decided to negotiate a different change than the change presented in the recommended task and schedule adjustment to have attributes associated with the tasks of the work and task schedule changed in a different way, the task organizer component 204 can receive such negotiation indication (e.g., negotiation message or selection) from the user 108 via an interface(s) of the TMC 128, communication device 102, or VA 116, and the task organizer component 204 can negotiate with the user 108 to determine an acceptable change to the attributes associated with the tasks of the work and task schedule of the user 108, in accordance with the desires of the user 108 and the task management criteria.

In some embodiments, in connection with negotiations with a user(s) (e.g., users 108, 110, and/or 112) or other type of communication with a user(s), the TMC 128 can learn, determine, and implement, or facilitate implementing, respective (e.g., different) VA personalities that can be utilized by a VA(s) (e.g., VAs 116, 118, and/or 120) during communications or negotiations with a user(s), based at least in part on a context associated with the user(s) and/or the interaction between the user(s), the VA(s), and/or the TMC 128. For instance, during a negotiation with a user 108 regarding a recommended adjustment to the work and task schedule of the user 108 that is taking place using the VA 116, the TMC 128, employing the task organizer component 204 and/or AI component 206, can learn or determine a context associated with the user 108 and the interaction between the user 108, VA 116, and TMC 128, based at least in part on the results of analyzing information (e.g., conversation, biometric information, feedback information, or other information) relating to the interaction and historical information relating to the user 108, tasks, work and task schedules, previous interactions between the user 108, the VA 116, and/or the TMC 128. Based at least in part on the context, the TMC 128 can learn or determine a desirable (e.g., suitable, enhanced, or optimal) VA personality, VA voice attributes (e.g., cadence, speed, language, vocabulary, or other voice attribute of the virtualized voice of the VA), and/or words for the VA 116 to convey (e.g., present or speak) to the user 108 during the interaction (e.g., negotiation) to achieve a desired (e.g., favorable, suitable, or optimal) result for the interaction (e.g., reach a desirable resolution to a negotiation, or motivate the user 108 to perform tasks better and/or more quickly).

For example, if the TMC 128 determines that the context is that the interaction is relatively tense and the user 108 is being somewhat combative or resistant to the work and task schedule recommendation, and the information analysis indicates that the user 108 may be more responsive or agreeable when a tense situation is diffused with some humor or levity, the TMC 128 can determine (e.g., adaptively determine) that the VA 116 is to utilize a VA personality and words that can inject some levity into the interaction to facilitate reducing the tension of the interaction and trying to get the user 108 to be agreeable to the work and task schedule recommendation or a suitable alternative change to the work and task schedule. In response to such determination, during the conversation with the user 108, the VA 116 can employ a VA personality, virtualized voice attributes, and wording (e.g., wording that includes a humorous anecdote, joke, or comment) that injects some levity into the conversation with the user 108. The TMC 128 can gauge the reaction or response of the user 108 to the presentation of the words, including the levity, by the VA 116. Based at least in part on the results of analyzing the reaction or response of the user 108, the TMC 128 can determine whether the VA personality (e.g., VA personality with levity), virtualized voice attributes, and/or wording are producing a desirable result or effect with regard to the interaction, and can determine whether further adaptation of the VA personality, virtualized voice attributes, and/or wording presented by the VA 116 is to be performed (e.g., due to the result or effect with regard to the interaction being less than desirable; or due to a change in context that indicates a further adaptation of the VA personality, virtualized voice attributes, and/or wording presented by the VA 116 can be desirable), or is not to be performed at that time (e.g., due to the result or effect with regard to the interaction being desirable).

As another example, with regard to a different user (e.g., user 110) who has a different personality than the user 108, if the TMC 128 determines that the context is that the interaction is relatively tense and the user 110 is being somewhat combative or resistant to a work and task schedule recommendation, and the information analysis indicates that the user 110 may be more responsive or agreeable when engaged in calmer conversation that includes a more detailed explanation regarding the recommendation, the TMC 128 can determine (e.g., adaptively determine) that the VA 118 is to utilize a VA personality and words that can be calming in nature to facilitate reducing the tension of the interaction and trying to get the user 110 to be agreeable to the work and task schedule recommendation or a suitable alternative change to the work and task schedule. In response to such determination, during the conversation with the user 110, the VA 118 can employ a VA personality, virtualized voice attributes, and wording (e.g., wording that includes more detailed explanation regarding the recommendation) that can be more calm in nature and more informational with regard to the recommendation. The TMC 128 can gauge the reaction or response of the user 110 to the presentation of the words (e.g., the calmer and more informational presentation) by the VA 118. Based at least in part on the results of analyzing the reaction or response of the user 110, the TMC 128 can determine whether the VA personality, virtualized voice attributes, and/or wording are producing a desirable result or effect with regard to the interaction. The TMC 128 can determine whether or not further adaptation of the VA personality, virtualized voice attributes, and/or wording presented by the VA 118 is to be performed based at least in part on the results of analyzing the reaction or response of the user 110, and whether the VA personality, virtualized voice attributes, and/or wording presented by the VA 118 are producing a desirable result or effect with regard to the interaction.

In certain embodiments, the TMC 128 can monitor and measure progress (e.g., improvement in abilities) of the users (e.g., users 108, 110, and/or 112) across the performance of various tasks, and, from such monitoring and measuring, the TMC 128 can learn the respective levels of expertise (e.g., mastery) of respective users with regard to performing those tasks or other similar tasks (e.g., other tasks determined to be sufficiently similar (e.g., sufficiently similar characteristics) to those tasks in satisfaction of a defined task similarity criterion). For instance, in an example scenario, the TMC 128 can receive task-related information, feedback information, and/or other information related to certain tasks performed by or associated with various users (e.g., users 108, 110, and/or 112). The TMC 128, employing the task organizer component 204, AI component 206, and/or expertise component 210, can analyze (e.g., perform an AI-based analysis on) such information to measure and learn how well the respective users perform the respective tasks. Based at least in part on the results of such analysis, the task organizer component 204, AI component 206, and/or expertise component 210 can learn, measure, or determine the respective abilities or expertise (e.g., respective levels of expertise or mastery) of the respective users in performing such tasks or other similar tasks. Based at least in part on the respective abilities or expertise of the respective users (e.g., users 108, 110, and/or 112) with regard to such tasks or other similar tasks, the task organizer component 204 can determine which tasks to assign to which users, determine allocations of time for users to perform tasks, and/or determine other attributes associated with such tasks with respect to users to which such tasks are assigned. For example, based at least in part on the respective abilities or expertise of the respective users (e.g., users 108, 110, and/or 112) with regard to such tasks or other similar tasks, the task organizer component 204 can determine that a particular task is to be assigned to user 108, instead of user 110 or user 112, because the task organizer component 204 or expertise component 210 determined that it can be desirable (e.g., wanted or required) for the particular task to be performed by a user that has a relatively higher level of expertise with regard to such task, and the user 108 was determined to have that higher level of expertise, whereas user 110 and user 112 were determined to not have such higher level of expertise. Additionally or alternatively, the task organizer component 204 can determine an amount of time to allocate for the user 108 to perform such particular task based at least in part on the higher level of expertise of the user 108, historical amounts of time for performance of the task by the user 108 or other users (e.g., taking into account their respective levels of expertise with respect to performing the particular task or a similar task), or a predicted amount of time (e.g., as predicted based on the AI-based analysis) that it will take for the user 108 to perform the particular task. The task organizer component 204 can adjust (e.g., adaptively adjust) the scheduling of tasks for the user 108, including adjusting attributes associated with the tasks, to include the particular task in the group of tasks the user is to perform and/or to allocate the determined amount of time for performance of the particular task by the user 108.

As an alternative example scenario relating to expertise, if the user 108 is unavailable or unable to accommodate having to perform the particular task, or if it is otherwise desirable (e.g., desirable to give another user more experience in performing such task) to assign the particular task to another user (e.g., user 110), the task organizer component 204 can assign the particular task to the other user 110, and can allocate a desirable (e.g., suitable or sufficient) amount of time for the user 110 to perform the particular task (e.g., an amount of time that can be longer than the amount of time that would have been allocated to user 108, since user 110 has a relatively lower expertise level than the user 108 with respect to that particular task). In some embodiments, based at least in part on analysis (e.g., which can comprise an AI-based analysis) of the information relating to the users and the task, the task organizer component 204 can learn, determine, or infer a difference(s) between the level of expertise associated with the user 110 and the level(s) of expertise associated with the user 108 (and/or another user(s)) with respect to the task. The task organizer component 204 can adaptively adjust one or more attributes (e.g., amount of time allocated to perform the task, instructions for performing the task, or other attribute) associated with the task based at least in part on the difference(s) between the level of expertise of the user 110 and the level of expertise(s) of the user 108 (and/or another user(s)) and/or based at least in part on other performance metrics with respect to the task, in accordance with the defined task management criteria.

The TMC 128 can continue to collect and store task-related information, feedback information, and/or other information relating to the users, including user 110, and monitor performance of tasks by users, including improvements in the performance of tasks made by the users. For example, if the user 110 had been assigned the particular task, as described in the alternative example scenario, and since then had performed that particular task and/or other tasks similar thereto on a number of occasions, based at least in part on the results of analysis (e.g., which can include AI-based analysis) of the additional task-related information, feedback information, and/or other information collected by the TMC 128, the task organizer component 204, AI component 206, and/or expertise component 210 can learn, identify, measure, and/or determine that, since the user 110 has been performing the particular tasks and/or other similar tasks (e.g., tasks that satisfy a defined similarity criterion with respect to the particular task), the user 110 has made improvement in performance of such tasks and has been taking relatively less time to perform such tasks, as compared to the first time or previous times that the user 110 was assigned the particular task. Based at least in part on learning, identifying, and/or determining that the user 110 has made such improvement in performance of such tasks and has been taking relatively less time to perform such tasks, the task organizer component 204 can determine that, with respect to the user 110, the attributes associated with the particular task can be adjusted (e.g., adaptively adjusted) to allocate less time for the user 110 to perform the particular task or similar task in future task assignments, assign the particular task or similar task on a more frequent basis in future task assignments, and/or assign the user 110 a task that can be somewhat similar to, but relatively more difficult than, the particular task or similar task; and/or the expertise component 210 can increase the expertise level associated with the user 110 with regard to the particular tasks and/or similar tasks.

In certain embodiments, the TMC 128 can adjust (e.g., adapt, modify, alter, or change) instructions for performing a task based at least in part on learning how various users have been performing the task or similar tasks, and/or information relating to the task or similar tasks that is received from a data source (e.g., via a data source device 130). For instance, the TMC 128 can monitor one or more users (e.g., users 108, 110, and/or 112) who are performing the particular task or similar tasks. Based at least in part on the monitoring, the TMC 128 can receive task-related information, feedback information, and/or other information relating to the performance of the particular task or similar tasks by the one or more users (e.g., users 108, 110, and/or 112). Based at least in part on the results of an analysis (e.g., AI-based analysis) of such information, the TMC 128, employing the task organizer component 204, AI component 206, and/or expertise component 210, can learn or determine which user(s) is performing the particular task or similar task, or a sub-task of the particular task or similar task, well (e.g., better than another user(s) and/or sufficiently good to satisfy a defined task management criterion relating to task performance), tasks, the actions the user(s) is performing or techniques the user(s) is using to perform the particular task or similar task, and/or the instructions, or portion thereof, the user(s) is following in performing the particular task or similar task; and/or can learn or determine which other user(s) is not performing the particular task or similar task well, the other actions the other user(s) performed, the other techniques the other user(s) used to perform the particular task or similar task, and/or the other instructions, or portion thereof, the other user(s) followed in performing the particular task or similar task. Based at least in part on the analysis results and such learning or determinations, the TMC 128 can learn or determine which actions performed, techniques used, or instructions followed by the well-performing user(s) resulted in the favorable (e.g., good, better, improved, optimal, or otherwise desirable) performance of the particular task or similar task, or sub-task thereof, and/or which other actions performed, other techniques used, or other instructions followed by the other under-performing user(s) resulted in the unfavorable (e.g., relatively poor, unacceptable, or otherwise undesirable) performance of the particular task or similar task, or sub-task thereof. Based at least in part on the analysis results and such learning or determinations relating to favorable or unfavorable performance of the particular task or similar task, or sub-task thereof, the TMC 128 (e.g., the task organizer component 204, AI component 206, and/or expertise component 210) can adaptively adjust (e.g., modify and enhance) attributes (e.g., action-related, technique-related, and/or instruction-related attributes) associated with the particular task or similar task, or sub-task(s) thereof, by adjusting the actions to be performed by a user for the particular task or sub-task(s), techniques to be used by the user to perform the particular task or sub-task(s), and/or the instructions the user is to follow when performing the particular task or sub-task(s), to facilitate enhancing performance of the particular task or sub-task(s) thereof by users.

The TMC 128, employing the notification component 208 and communicator component 202, can communicate a message (e.g., notification, recommendation, or instruction message) to a user (e.g., 108) who is to perform the particular task, the communication device (e.g., 102) associated with the user, and/or VA (e.g., 116) associated with the user advise or instruct the user with regard to the updated (e.g., adjusted and enhanced) actions to be performed by the user for the particular task or sub-task(s), techniques to be used by the user to perform the particular task or sub-task(s), and/or the instructions the user is to follow when performing the particular task or sub-task(s). The user (e.g., 108) can perform the updated actions, utilize the updated techniques, and/or follow the updated instruction when performing the particular task to facilitate enhancing performance of the particular task and the outcome from performance of the particular task (and/or other tasks). The TMC 128 can continue to monitor performance of tasks by users, including improvements in the performance of tasks made by the users, and can continue to update and enhance actions, techniques, and/or instructions for performance of tasks by users as the TMC 128 learns enhancements that can be made with regard to actions, techniques, and/or instructions for performance of tasks by users, in accordance with the defined task management criteria.

In certain embodiments, the task organizer component 204 can adjust priority levels associated with tasks in response to a change in context (e.g., a change in circumstances). For instance, the task organizer component 204 can be monitoring the performance of tasks by users (e.g., user 108, 110, and/or 112), monitoring incoming tasks (e.g., new tasks) that have to be scheduled and performed, and monitoring information, including priority information, relating to tasks, and can receive information relating thereto. Based at least in part on the results of an analysis (e.g., which can include an AI-based analysis) of such information relating to those tasks and users, the task organizer component 204 can, for example, determine whether a priority level associated with a task (e.g., a previously scheduled task) has changed, determine a priority level associated with a new task, determine whether a priority level associated with a new task impacts a priority level associated with a previously scheduled task, and/or determine whether progress (or lack thereof) of a user in performing tasks is having an impact on a priority level associated with a task.

If, from the analysis results, the task organizer component 204 determines that a priority level associated with a previously scheduled task assigned to a user 108 has changed, the task organizer component 204 can adaptively adjust attributes associated with the tasks, including that previously scheduled task, assigned to the user 108 to reflect or account for the change in priority level associated with the previously scheduled task (e.g., move up a due date for completion of that task and/or indicate an increased priority level for that task, if the information or context indicates that its priority level has been increased and/or due date has been moved to an earlier date; move back a due date and/or indicate a decreased priority level for that task, if the information or context indicates that its priority level has been decreased and/or due date has been moved to a later date; or increase the priority level for that task, if the user 108 has fallen behind schedule in performing tasks, including that task, and the due date for completion of that task is near). If, from the analysis results, the task organizer component 204 determines that a priority level associated with a new task that is to be assigned to the user 108, the task organizer component 204 can adaptively adjust attributes associated with the tasks, including that new task, assigned to the user 108 to reflect or account for the respective priority levels associated with the respective tasks assigned to the user 108. For instance, if the information indicates that the new task has a high priority level and/or a relatively short amount of time available for completion of the new task, the task organizer component 204 can assign a high priority level to the new task and can reorganize the task schedule of the user 108 to have the user 108 perform the new higher priority task before another lower priority task(s).

If, from the analysis results, the task organizer component 204 determines that the user 108 is falling behind on some tasks assigned to the user 108, and, as a result, a task, which had a lower priority, is almost due for completion, the task organizer component 204 can adaptively adjust attributes associated with the tasks, including that task, assigned to the user 108 to increase the priority level associated with that task, and/or rearrange the sequence or scheduling of performance of task by the user 108 to move up the task in the sequence or schedule. The task organizer component 204 also can employ the notification component 208 to present a notification message relating to that task to the user 108, wherein the notification message can indicate that the priority level associated with that task has been increased and/or that task has been moved up the task in the sequence or schedule of the user 108.

In some embodiments, the TMC 128 can determine and/or recommend personal (e.g., leisure) tasks or hobbies for or to a user (e.g., user 108). In that regard, as still another example scenario, the TMC 128 can collect task-related information, feedback information, and/or other information relating to users (e.g., users 108, 110, and/or 112), and, in particular, user 108. The feedback information can comprise, for example, information (e.g., answers to questions presented to user 108 by the TMC 128) relating to interests in activities (e.g., personal or leisure activities, hobbies, topics, or events) provided to the TMC 128 by the user 108, information relating to online searches or activity of the user 108 (e.g., Internet searches or activity, information requested from the VA 116 or communication device 102 by the user 108), information relating to television or media watching or listening by the user 108, and/or other information. Based at least in part on the results of analysis (e.g., which can include AI-based analysis) of the additional task-related information, feedback information, and/or other information collected by the TMC 128, the TMC 128, employing the task organizer component 204, AI component 206, and/or exploration component 212, can learn and/or determine that the user 108 has or may have an interest in a particular activity (e.g., playing a musical instrument, playing a sport, writing fiction or non-fiction stories, riding a bicycle, playing electronic games, traveling, or other type of activity). Based at least in part on learning and/or determining that the user 108 has or may have an interest in the particular activity, the task organizer component 204 and/or exploration component 212 can determine one or more personal or leisure tasks relating to the particular activity, generate a recommendation that the user 108 perform the one or more tasks and/or otherwise recommend that the user 108 engage or participate in the particular activity, and/or recommend places (e.g., physical businesses or locations) or online locations (e.g., websites) where the user 108 can pursue or participate in the particular activity. The TMC 128, employing the notification component 208 and communicator component 202, can communicate a message, comprising information regarding or relating to such recommendation(s) relating to the particular activity, to the user 108, the communication device 102 associated with the user 108, and/or the VA 116 associated with the user 108. The TMC 128, by determining or generating certain tasks (e.g., leisure, educational, hobby, or personal interest tasks), based at least in part on a determined or inferred interest of the user in such tasks, can enable task learning (e.g., new task learning) by introductory steps during leisure hours of the user. In some embodiments, the TMC 128 also can allow a user (e.g., user 108) to set some of the tasks of the user to include desired personal task choices of the user with regard to personal (e.g., leisure, educational, hobby, or personal interest) tasks or even some work tasks (e.g., when doing so is in accordance with the defined task management criteria).

If the user 108 desires to pursue or participate in the particular activity, the user 108 can accept the scheduling of the one or more personal or leisure tasks in the user's schedule or calendar (e.g., electronic calendar) and/or accept another recommendation to pursue or participate in the particular activity, as presented by the TMC 128. With regard to the one or more personal or leisure tasks, in response to the user 108 accepting the recommendation to schedule such tasks, the task organizer component 204 can modify the schedule of the user 108 to include the one or more personal or leisure tasks (e.g., during personal time of the user 108), wherein the schedule of the user can comprise work task information and personal task information. If the user 108 is interested in pursuing or participating in the particular activity, but does not agree with the specific recommendation(s), the user 108 can interact with the TMC 128 via an interface(s) of the communication device 102, VA 116, and/or TMC 128 to negotiate a modification to the recommendation(s). If, instead, the user 108 does not desire to pursue or participate in the particular activity, the user 108 can interact with the TMC 128 via an interface(s) of the communication device 102, VA 116, and/or TMC 128 to indicate that the user 108 is not interested in pursuing or participating in the particular activity. In such case, the TMC 128 (e.g., task organizer component 204, AI component 206, and/or exploration component 212) can incorporate such feedback information regarding the user 108 declining to purse or participate in the particular activity in its information analysis, including not adding the one or more personal or leisure tasks to the user's schedule or calendar, and/or refining or adjusting determinations regarding activities for which the user 108 may have an interest.

In certain embodiments, the task organizer component 204 can determine whether a task can and/or should be divided (e.g., split or partitioned) up into multiple sub-tasks, and, if so, can determine the sub-tasks of the task, based at least in part on the results of analyzing information relating to the task, including type of task, attributes associated with the task, historical information relating to performance of the task by users, and/or other task-related information. Also, in a case where a task is being divided up into sub-tasks, the task organizer component 204 also can determine whether it can be more desirable (e.g., more suitable, more favorable, or optimal) or at least appropriate for the sub-tasks of the task to be performed by the same user (e.g., user 108) or whether it can be more desirable or at least appropriate for respective sub-tasks of the task to be performed by respective users (e.g., users 108, 110, and/or 112), based at least in part on the analysis results, in accordance with the defined task management criteria.

The task organizer component 204 (or other component of the TMC 128) can manage or facilitate managing various notifications (e.g., alerts, task changes, schedule changes, updates, instructions, reminders, or other type of notification) by the notification component 208, or utilizing the notification component 208 to issue notifications. For example, if the task organizer component 204 has adaptively adjusted attributes associated with tasks assigned to the user 108, the task organizer component 204 can communicate information relating to the task-related adjustments to the notification component 208. In response, the notification component 208 can generate a notification message relating to such task-related adjustments, and can present (e.g., communicate or display) the notification message to the user 108 via an interface(s) associated with the TMC 128, communication device 102, or VA 116. As another example, if the task organizer component 204 determines that the user 108 has fallen behind schedule and a due date for completion of a task by the user 108 is fast approaching, the task organizer component 204 can communicate information, which can indicate that a task due date is fast approaching and a reminder is to be issued to the user 108, to the notification component 208. In response, the notification component 208 can generate a reminder or alert message that can indicate the due date for completion of the task is fast approaching, and can present (e.g., communicate or display) the reminder or alert message to the user 108 via an interface(s) associated with the TMC 128, communication device 102, or VA 116.

The TMC 128 also can comprise a schedule component 214 (e.g., a schedule and calendar component) that can present (e.g., communicate, display, or otherwise present to) respective users (e.g., users 108, 110, and/or 112) with respective schedules (e.g., schedule in the form of a calendar or list) of respective tasks to be performed by the respective users and/or other desired information relating to the tasks, users, events, or other matters. For instance, based at least in part on respective task organization or scheduling information for respective users (e.g., users 108, 110, and/or 112), as determined by the TMC 128 (e.g., the task organizer component 204, AI component 206, or other component of the TMC 128), the schedule component 214 can generate respective schedules of respective tasks to be performed by the respective users and/or the other desired information. The schedule component 214 (e.g., via the communicator component 202) can present (e.g., communicate, display, or otherwise present) respective schedules of respective tasks to be performed by the respective users and/or the other desired information to the respective users (e.g., users 108, 110, and/or 112), respective communication devices (e.g., communication devices 102, 104, and/or 106) associated with the respective users, or respective VAs (e.g., VAs 116, 118, and/or 120) associated with the respective users.

In some embodiments, the schedule component 214 can allow a user (e.g., user 108, 110, or 112) to modify the presentation of the user's schedule or other information being presented to the user. For instance, via the schedule component 214 and an interface(s) (e.g., display screen(s)) of the TMC 128, communication device (e.g., communication device 102, 104, or 106), or VA (e.g., VA 116, 118, or 120), the user can modify the presentation of the user's schedule to present the schedule information (or portion thereof) of the user to display schedule information for an hour, a day, a week, a month, a year, or portion thereof, or for another desired time period. If desired, via the schedule component 214 and an interface(s) (e.g., speakers, earbuds, or earphones) of the TMC 128, communication device, or VA, the user can modify the presentation of the user's schedule to present a desired portion of the schedule information of the user in audio or verbal form.

As tasks are completed by users, progress is made on tasks by users, new tasks are added, priority levels associated with tasks are set or modified, task completion due dates associated with tasks are set or modified, tasks are reassigned from one user to another user, and/or other changes are made with respect to tasks or users, as determined by the TMC 128, the schedule component 214 can update (e.g., modify, adjust, or change) the respective schedules of respective tasks to be performed by the respective users and/or the other desired information relating to the tasks, users, events, or other matters to reflect or account for (e.g., in accordance with) the completion of tasks by users, the progress made on tasks by users, the addition of new tasks, the setting or modifying of priority levels associated with tasks, the setting or modifying of task completion due dates associated with tasks, the reassignment of tasks from one user to another user, and/or the other changes made with respect to tasks or users. For instance, with regard to progress made on a task by a user (e.g., user 108), the task organizer component 204 can monitor the amount of progress the user 108 is making on a task based at least in part on the results of analyzing information relating to progress being made on that task. As the amount of progress on the task is determined to increase, the task organizer component 204 can communicate task progress information relating to the progress being made on the task by the user 108 to the schedule component 214 and/or notification component 208. In response to receiving the task progress information, the schedule component 214 can update (e.g., modify) information in the task schedule of the user 108 to indicate the amount (e.g., updated or increased) of progress made towards completion of the task, and/or the notification component 208 can present notification information, which can indicate the amount of progress made towards completion of the task, to the user 108 (e.g., via an interface(s) of the TMC 128, communication device 102, or VA 116), and/or to another entity (e.g., a supervisor, manager, or other entity associated with the user 108 or the enterprise).

As another example, if, based at least in part on the results of analyzing task-related information, feedback information, and/or other information, the task organizer component 204 determines that the user 108 is falling behind schedule on performing or completing a task, the task organizer component 204 can communicate task update information relating to the lack of progress being made on the task (e.g., falling behind schedule on the task) by the user 108 to the schedule component 214 and/or notification component 208. In response to receiving the task update information, the schedule component 214 can update (e.g., modify) information in the task schedule of the user 108 to indicate the lack of progress being made towards completion of the task by the user 108 (e.g., can update information to highlight, emphasize, or increase the priority level of the task), and/or the notification component 208 can present notification information, which can indicate the lack of progress being made towards completion of the task by the user 108 (e.g., can send a high priority notification message regarding the task, and/or can send a notification message indicating that the user is behind schedule on the task and/or the priority level of the task has been increased), to the user 108 (e.g., via an interface(s) of the TMC 128, communication device 102, or VA 116), and/or to another entity (e.g., a supervisor, manager, or other entity associated with the user 108 or the enterprise)

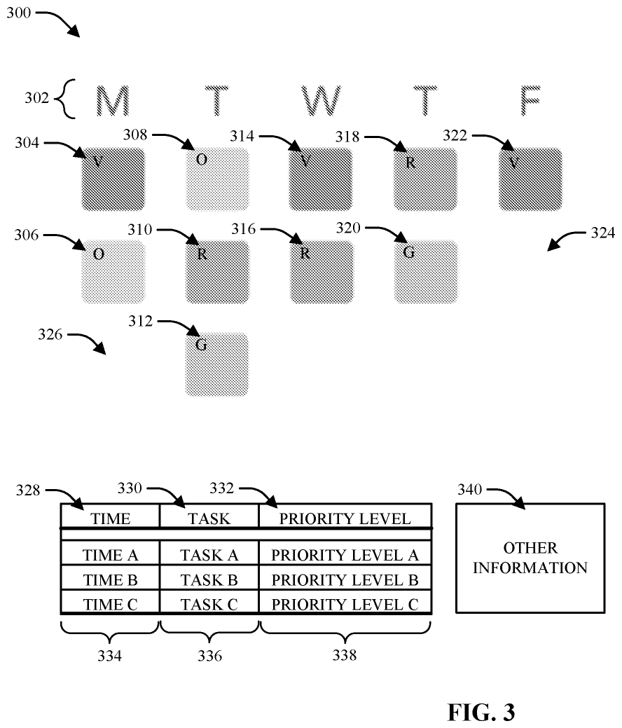

Referring briefly to FIG. 3 (along with FIGS. 1 and 2), FIG. 3 presents a diagram of a non-limiting example calendar 300 (e.g., electronic calendar or schedule) that can present information relating to a schedule of tasks and/or other desired information to a user, in accordance with various aspects and embodiments of the disclosed subject matter. The schedule component 214 can generate the calendar 300 based at least in part on schedule-related information relating to tasks assigned to or associated with the user (e.g., user 108, 110, or 112) and/or other desired information, as determined by the task organizer component 204 or other component of the TMC 128. The example calendar 300 can be presented (e.g., communicated or displayed) by the schedule component 214 via an interface(s) of the TMC 128, communication device (e.g., communication device 102, 104, or 106), or VA (e.g., VA 116, 118, or 120).

The example calendar 300 can display a header indicating days (e.g., work days) of the week, such as Monday, Tuesday, Wednesday, Thursday, and Friday (M T W T F), as indicated at reference numeral 302. The example calendar 300 also can comprise respective information fields under and/or in proximity to the respective days, wherein the respective information fields can comprise respective schedule information associated with the user and/or can be utilized to access (e.g., drill down to or otherwise access) other schedule information (e.g., more detailed schedule information) and/or other desired information associated with the user or tasks. For instance, as presented in the example calendar 300, the calendar 300 can comprise information fields 304 and 306 underneath Monday, information fields 308, 310, and 312 underneath Tuesday, information fields 314 and 316 underneath Wednesday, information fields 318 and 320 underneath Thursday, and information field 322 underneath Friday. Information fields 304, 308, 314, 318, and 322 are associated with a first week of the calendar 300, information fields 306, 310, 316, and 320 are associated with a second week of the calendar 300, and information field 312 is associated with a third week of the calendar 300. Field 324 associated with the second week and field 326 associated with the third week are blank fields or regions that can indicate there is nothing scheduled for the user on those days, the user has a day off of work on those days, or the schedule information and/or other information is unavailable for those days.

In some embodiments, in the example calendar 300, the respective information fields (e.g., 304 through 322) can be respectively color coded, or otherwise respectively coded, wherein the respective coding can be associated with or indicative of respective tasks (e.g., sub-tasks of an overall task or project). For instance, the same color on multiple information fields can indicate or represent that the respective sub-tasks associated with those respective information fields can be related to or dependent on each other (e.g., can be coherent dependent sub-tasks). For example, as shown in the example calendar 300, information fields 304, 314, and 322 can be presented in a first color (e.g., violet (V)), information fields 306 and 308 can be presented in a second color (e.g., orange (O)), information fields 310, 316, and 318 can be presented in a third color (e.g., red (R)), and information fields 312 and 320 can be presented in a fourth color (e.g., green (G)). These respective color codes can indicate that information fields 304, 314, and 322 comprise respective sub-tasks that have some relation or dependency with each other

It is to be appreciated and understood that, in certain embodiments, a day or other time period of the calendar can comprise more than one code (e.g., more than one color code). For instance, if a first information field associated with a first day of the calendar comprises first schedule information relating to sub-tasks of a first task and sub-tasks of a second task, a second information field associated with a second day of the calendar comprises second schedule information relating to sub-tasks of the second task, and a third information field associated with a third day of the calendar comprises third schedule information relating to sub-tasks of the first task, the schedule component 214 can generate the calendar to have the first information field comprise a first code (e.g., first color code) relating to sub-tasks of the first task and a second code relating to sub-tasks of the second task, the second information field comprise the second code relating to the sub-tasks of the second task, and the third information field comprise the first code relating to the sub-tasks of the first task.

In certain embodiments, the schedule component 214 can generate the calendar 300 such that the user (e.g., user 108, 110, or 112) can access (e.g., drill down to) additional schedule information and/or other information by selecting (e.g., clicking or double-clicking on) an information field (e.g., information field 304, 306, or 308, or other desired information field) associated with a desired day (or other time period) in the calendar 300. For instance, if the user selected information field 304 in the calendar 300, in response, the schedule component 214 can present more detailed schedule information relating to the tasks and/or other information for or relevant to the day (e.g., Monday) associated with the selected information field 304. As an example, in response, the schedule component 214 can present schedule information comprising time of day 328, task information 330, priority information 332, and/or other desired schedule information. With regard to time of day 328, the calendar 300 can present (e.g., list or display) respective times of day, such as time A, time B, and time C, as indicated at reference numeral 334, wherein the time of day of the respective times can indicate the time the user is scheduled to begin working on the associated task and/or the amount of time allocated to perform or complete the task. With regard to task information 330, the calendar 300 can present (e.g., list or display) respective items of task information, such as task A, task B, and task C, as indicated at reference numeral 336, wherein the respective items of task information can identify or present other task-related information relating to those respective tasks. With regard to priority information 332, the calendar 300 can present (e.g., list or display) respective priority levels associated with the respective tasks, such as priority level A associated with task A, priority level B associated with task B, and priority level C associated with task C, as indicated at reference numeral 338. As desired, additional or alternate schedule information can be presented in this more detailed presentation of the schedule information. In some embodiments, the schedule component 214 can present other desired information 340 (e.g., comments relating to the task provided by a supervisor, updates relating to the task, or other desired information), which can be relevant to the task and work schedule and/or user, in proximity to the additional schedule information presented. In some embodiments, the schedule information and/or other information may comprise even more information relating to the tasks and/or user (e.g., instructions on how to perform a task, the name of a supervisor associated with the task, a client for whom the task is being performed, or other desired information). The schedule component 214 can allow and enable the user to access such additional information by selecting an information field (e.g., time of day field, task field, or priority field) in the schedule information (e.g., hourly work and task schedule for that day) presented for that time period (e.g., that day, or portion thereof).

The schedule component 214 also can allow and enable the user (e.g., user 108, 110, or 112) to customize the calendar 300, including customizing information fields, customizing the types of information fields presented in the calendar 300, or portion (e.g., hierarchical level) thereof, customizing the amount or type of information presented in information fields, customizing coding (e.g., color coding, highlighting, emphasizing, or other coding) of information fields, and/or other desired customization of information presented in the calendar 300.

In some embodiments, the TMC 128 can comprise a reward component 216 that can present users with rewards (e.g., electronic rewards or badges, financial rewards, or other rewards) to reward users for desirably (e.g., suitably, more than suitably, timely, or optimally) performing tasks, and/or to motivate or incentivize users to desirably perform tasks, in accordance with the defined task management criteria. The task organizer component 204, expertise component 210, reward component 216 itself, another component of the TMC 128, or an entity (e.g., an employer of a user; an operator of the TMC 128 or application associated therewith; or a business), or even a user himself or herself, can determine respective rewards that can be presented to respective users (e.g., users 108, 110, and/or 112) for respective accomplishments (e.g., completion of task, completion of an overall project or goal, comprising a number of tasks, or other type of accomplishment) of the respective users, in accordance with the defined task management criteria. For instance, an employer can set a desired reward (e.g., an electronic badge, a financial reward, tickets to an entertainment event, or other type of reward) that can be presented to users (e.g., employees) when they timely and successfully complete particular tasks (e.g., a major or difficult task); a business can provide promotional offers for products or services (e.g., free pizza or dinner, free smart phone or discount on a smart phone, a gift certificate or card having a certain financial value, or other type of promotional offer) to companies for companies to give to employees as rewards for completion of tasks, or as otherwise desired; and/or a user (e.g., user 108) can set a reward (e.g., user treating self to a nice dinner or tickets to an entertainment event) for himself or herself for timely and successfully completing a task (e.g., work task; or personal task, such as completing an educational or online class, or attaining a goal in learning to play a musical instrument (e.g., learning to play a song on a musical instrument)). The reward can be known to a user (e.g., user 108, 110, or 112) prior to performing the task or project, or can be a surprise reward that was not known to the user prior to performing the task or project. In some instances, the reward can vary based at least in part on various factors. For instance, the reward component 216 can present a user (e.g., user 108) with a first reward if the user is determined to have successfully completed a particular task on time; or the reward component 216 can present the user with a second reward, which is greater in value or prestige than the first reward, if the user is determined to have successfully completed the particular task significantly ahead of schedule, with a high degree of quality, and/or a high level of efficiency (e.g., performed the task at a significantly lower cost than projected).

In certain embodiments, if a user 108 has timely and successfully completed a particular (e.g., major) task, a set of tasks for a day or week, or achieved another type of accomplishment, the reward component 216 can present the user 108 a reward in the form of an electronic badge via an interface(s) of the TMC 128, communication device 102, or VA 116. The electronic badge can indicate that the user 108 has timely, successfully, and/or efficiently performed such task, performed the set of tasks for the day or week, or achieved another type of accomplishment. In some embodiments, the reward component 216 also can present (e.g., communicate or display) the electronic badge of the user 108 on other interfaces (e.g., interfaces of communication devices 104 and/or 106, and/or VAs 118 and/or 120) associated with other employees (e.g., users 110 and/or 112) so that the other employees can be made aware of the good job the user 108 has done. In other embodiments, if a user 108 has timely and successfully completed a particular task or achieved another type of accomplishment, the reward component 216 can present the user 108 with another type of reward (e.g., a financial reward; a product or service for free or at a discount; or other type of reward of financial value) that can indicate that the user 108 has timely, successfully, and/or efficiently performed such task or achieved another type of accomplishment.

With further regard to the AI component 206, the AI component 206 can perform an AI and/or ML-based analysis on data, such as user-related information, task-related information, feedback information, sensor information, biometric information, environmental information, demographic information relating to users, and/or other desired data, such as more fully described herein. In connection with or as part of such an AI or ML-based analysis, the AI component 206 can employ, build (e.g., construct or create), and/or import, AI and/or ML techniques and algorithms, AI and/or ML models (e.g., trained models), neural networks (e.g., trained neural networks), Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about attributes associated with tasks (e.g., type of task, amount of time to perform a task, level of expertise desired to perform a task, specifications associated with a task, or other characteristic associated with a task), determining or learning adaptive adjustments that can be made to attributes associated with tasks to enhance performance of tasks by users, determining or learning desirable assignments of tasks to users, determining or learning an allocation of time to perform a task, determining or learning a sequence of tasks to be performed by a user(s), determining or learning a partitioning of a task into a group (e.g., sequence) of sub-tasks, determining or learning about experience or a level of expertise of a user with regard to a task, determining or learning how to enhance a level of expertise of a user with regard a task, determining or learning an amount of time that it can be expected to take for a user to improve a level of expertise with regard to performing a task, determining or learning an enhancement that can be made to instructions for performing a task by a user, determining or learning personal or leisure tasks to recommend to a user, determining or learning VA attributes that can be utilized to communicate or negotiate with a user, determining or learning a level(s) of stress, fatigue, illness, or injury of a user, determining or learning a form of presentation and/or an interface(s) by which to present information to a user to enhance attention or response of the user to the information presented, determining or learning which information can be presented in accordance with data privacy laws, determining or learning a form of presentation and/or an interface(s) by which to present information to a user in accordance with data privacy laws, determining or learning other characteristics and features associated with the data, and/or automating one or more functions or features of the disclosed subject matter, as more fully described herein.

Based at least in part on the results of the analysis, the AI component 206 can determine, train, and generate a model that can relate to tasks and users, wherein the model can model or be representative of historical performance of tasks by users, characteristics (e.g., education, work experience or skill relating to tasks, age, personality, employment role or position, demographic, or other characteristics) associated with users, attributes associated with tasks, levels of user expertise associated with tasks, environments associated with users or tasks, and/or other features relating to the users (e.g., users 108, 110, and/or 112) and tasks to be performed by users, such as described herein. The AI component 206 can update (e.g., modify, adjust, or change), and further train and enhance, the model as additional data (e.g., task-related information, user feedback information, sensor information, biometric information, environmental information, or other information) associated with users or tasks is received and analyzed by the AI component 206. In some embodiments, as part of the data analysis, and the determining and training of the model, the AI component 206 can employ (and/or train) Markov chains, a neural network(s), or other AI-based or ML-based modeling, techniques, functions, or algorithms.

The AI component 206 can employ various AI-based or ML-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 206 can examine the entirety or a subset of the data (e.g., information associated with users, tasks, sensors, communication devices, VAs, or environments; or other data) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In accordance with various embodiments, the TMC 128 can comprise a processor component 218 that can work in conjunction with the other components (e.g., communicator component 202, task organizer component 204, AI component 206, notification component 208, expertise component 210, exploration component 212, schedule component 214, reward component 216, and data store 220) to facilitate performing the various functions of the TMC 128. The processor component 218 can employ one or more processors, microprocessors, or controllers that can process data, such as information relating to users, VAs, communication devices or other devices, interactions, events, contexts associated with users, tasks, or interactions, status or progress of tasks, status or progress of interactions associated with users, demographic data, data privacy, activities relating to interactions, environmental conditions associated with users, tasks, or interactions, identifiers or authentication credentials associated with users, entities, devices, or components, updates to user profiles of users, parameters, traffic flows, policies, defined task management criteria, algorithms (e.g., task management algorithm(s), AI-based algorithms, or other algorithms), protocols, interfaces, tools, and/or other information, to facilitate operation of the TMC 128, as more fully disclosed herein, and control data flow between the TMC 128 and other components (e.g., VAs, communication devices, devices, base stations, network devices of the communication network, data source devices, applications, or other component or device) or users associated with the TMC 128.

The data store 220 that can store data structures (e.g., user data, metadata), code structure(s) (e.g., modules, objects, hashes, classes, procedures) or instructions, information relating to users, VAs, communication devices or other devices, interactions, events, contexts associated with users, tasks, or interactions, status or progress of tasks, status or progress of interactions associated with users, demographic data, data privacy, activities relating to interactions, environmental conditions associated with users, tasks, or interactions, identifiers or authentication credentials associated with users, entities, devices, or components, updates to user profiles of users, parameters, traffic flows, policies, defined task management criteria, algorithms (e.g., task management algorithm(s), AI-based algorithms, or other algorithms), protocols, interfaces, tools, and/or other information, to facilitate controlling operations associated with the TMC 128. In an aspect, the processor component 218 can be functionally coupled (e.g., through a memory bus) to the data store 220 in order to store and retrieve information desired to operate and/or confer functionality, at least in part, to the communicator component 202, task organizer component 204, AI component 206, notification component 208, expertise component 210, exploration component 212, schedule component 214, reward component 216, processor component 218, data store 220, and/or other component of the TMC 128, and/or substantially any other operational aspects of the TMC 128.

With further regard to the communication network 114 depicted in FIG. 1, the communication network 114 can comprise one or more wireline communication networks and one or more wireless communication networks, wherein the one or more wireless communication networks can be based at least in part on one or more various types of communication technology or protocols, such as, for example, 3G, 4G, 5G, or x generation (xG) network, where x can be virtually any desired integer or real value; Wi-Fi; Gi-Fi; Hi-Fi; or other communication technology or protocol. The communication network 114 (e.g., a core network, cellular network, or a network comprising a core network, cellular network, and/or an IP-based network) can facilitate routing voice and data communications between a communication device(s) (e.g., communication devices (e.g., 102, 104, and/or 106), VAs (e.g., 116, 118, and/or 120), sensors (e.g., 122, 124, and/or 126), TMC(s) 128, data source device(s) 130, IoT device, or other communication device) and another communication device (e.g., another of such communication devices) associated with the communication network 114 in the communication network environment. The communication network 114 (e.g., core network or IP-based network of the communication network 114) also can allocate resources to the communication devices in the communication network 114, convert or enforce protocols, establish and enforce quality of service (QoS) for the communication devices, provide applications or services in the communication network 114 translate signals, and/or perform other desired functions to facilitate system interoperability and communication in the communication network 114 (e.g., wireless portion of the communication network 114 or wireline portion of the communication network 114). The communication network 114 further can comprise desired components, such as routers, nodes (e.g., general packet radio service (GPRS) nodes, such as serving GPRS support node (SGSN), gateway GPRS support node (GGSN)), switches, interfaces, controllers, etc., that can facilitate communication of data between communication devices in the communication network environment.

A RAN of the communication network 114 can be associated with (e.g., connected to) the core network (e.g., mobile core network) that can facilitate communications by communication devices (e.g., communication devices (e.g., 102, 104, and/or 106), VAs (e.g., 116, 118, and/or 120), sensors (e.g., 122, 124, and/or 126), TMC(s) 128, data source device(s) 130, IoT device, or other communication device) wirelessly connected to the communication network 114. A communication device can be communicatively connected to the core network via a base station. The core network can facilitate wireless communication of voice and data associated with communication devices associated with the communication network 114. The core network can facilitate routing voice and data communications between communication devices and/or other communication devices (e.g., phone, computer, VA, email server, multimedia server, audio server, video server, news server, financial or stock information server, other communication devices associated with the IP-based network (e.g., the Internet or an intranet) (not explicitly shown in FIG. 1) of or associated with the communication network 114.

In accordance with various embodiments, the communication network 114 can comprise a macro communication network and/or a micro communication network. The macro communication network can be, can comprise, or can be associated with a core network, a cellular network, an IP-based network, Wi-Fi, gigabit wireless (Gi-Fi) network, Hi-Fi network (e.g., providing higher gigabit data communication than Gi-Fi or Wi-Fi), Bluetooth, ZigBee, etc. The micro communication network can be associated with the macro communication network, wherein the micro communication network typically can operate in a defined local area (e.g., in or in proximity to a home, building, or other defined area). The micro communication network can be, can comprise, or can be associated with Wi-Fi, Gi-Fi, Hi-Fi, Bluetooth, ZigBee, or other communication technology, and/or can be associated with (e.g., connected to) the macro communication network. The micro communication network can be or can comprise, for example a local area network (LAN), that can facilitate connecting certain devices (e.g., communication devices) associated with the micro communication network to each other and/or to the macro communication network.

Respective communication devices (e.g., communication device, VA, TMC, sensor, or IoT device) can be associated with (e.g., communicatively connected to) the communication network 114 via a wireless communication connection or a wireline (e.g., wired) communication connection (e.g., via a cell and associated base station). The respective communication devices can operate and communicate in a communication network environment. At various times, a communication device can be communicatively connected via a wireless communication connection(s) to one or more RANs, which can comprise one or more base stations to communicatively connect the communication device to the communication network 114 to enable the communication device to communicate other communication devices associated with (e.g., communicatively connected to) the communication network 114 in the communication network environment. The one or more RANs can comprise, for example, a 3GPP universal mobile telecommunication system (UMTS) terrestrial RAN (UTRAN), an E-UTRAN (e.g., Long Term Evolution (LTE) RAN), 5G or other next generation (xG) RAN, a GSM RAN (GRAN), and/or other type of RAN(s) employing another type of communication technology.

As a communication device(s) (e.g., communication device, VA, TMC, sensor, or IoT device) is moved through a wireless communication network environment, at various times, the communication device(s) can be connected (e.g., wirelessly connected) to one of a plurality of base stations or APs (e.g., macro or cellular AP, femto AP, pico AP, wi-fi AP, wi-max AP, hotspot (e.g., hotspot 1.x, hotspot 2.x, where x is an integer number; communication device (e.g., communication device functioning as a mobile hotspot)) that can operate in the wireless communication network environment. An AP (e.g., base station) can serve a specified coverage area to facilitate communication by the communication device(s) or other communication devices in the wireless communication network environment. An AP can serve a respective coverage cell (e.g., macrocell, femtocell, picocell, or other type of cell) that can cover a respective specified area, and the AP can service mobile wireless devices, such as the communication device(s) located in the respective area covered by the respective cell, where such coverage can be achieved via a wireless link (e.g., uplink (UL), downlink (DL)). When an attachment attempt is successful, the communication device(s) can be served by the AP and incoming voice and data traffic can be paged and routed to the communication device(s) through the AP, and outgoing voice and data traffic from the communication device(s) can be paged and routed through the AP to other communication devices in the communication network environment. In an aspect, the communication device(s) can be connected and can communicate wirelessly using virtually any desired wireless technology, including, for example, cellular, Wi-Fi, Gi-Fi, Hi-Fi, Wi-Max, Bluetooth, wireless local area networks (WLAN), or other communication technology.

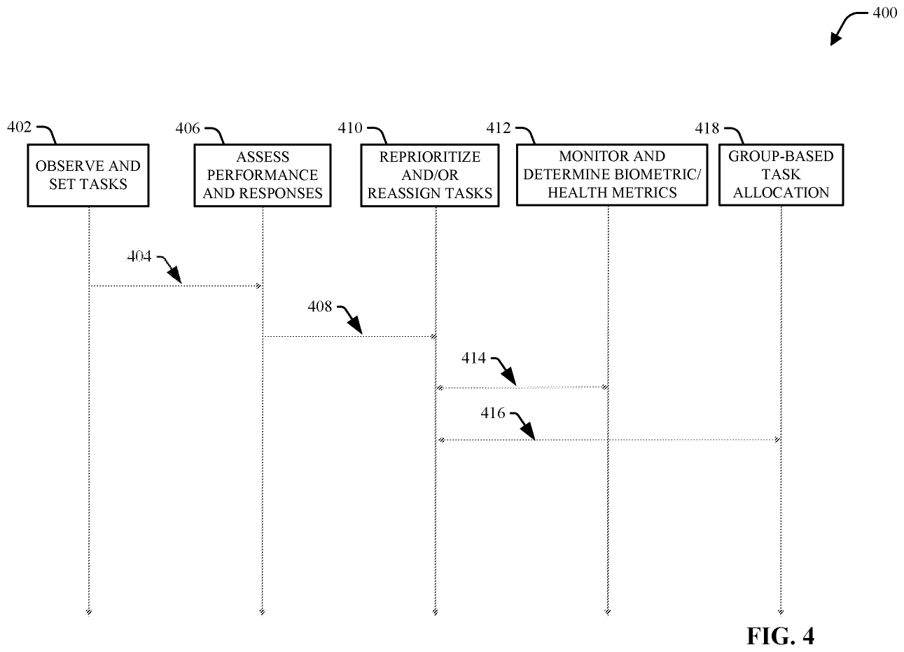

Turning to FIG. 4 (along with FIGS. 1 and 2), FIG. 4 depicts a diagram of a non-limiting example task management flow 400 for desirably (e.g., suitably, enhancedly, or optimally) managing the assignment of tasks to users, the performance of tasks by users, and adaptively adjusting attributes associated with tasks, in accordance with various aspects and embodiments of the disclosed subject matter. As indicated at reference numeral 402 of the task management flow 400, the TMC 128 can monitor and observe users (e.g., users 108, 110, and/or 112) and tasks, including information relating to tasks, can collect information from users, information relating to users and/or tasks (e.g., from other sources, such as communication devices (e.g., 102, 104, and/or 106), VAs (e.g., 116, 118, and/or 120), sensors (e.g., 122, 124, and/or 126), applications (e.g., applications installed on or accessed by communication devices or VAs), data source device(s) 130, and/or other data sources or devices), and, based at least in part on the results of an analysis of such information and observation, can set respective tasks for respective users, such as described herein. For example, the TMC 128 can collect data from users (e.g., users 108, 110, and/or 112) by presenting questions relating to the users, tasks, or work environment and receiving feedback (e.g., answers) regarding those questions from the users, collect data relating to biometric features associated with the users, or measure the biometric features associated with the users, via the user of the communication devices, VAs, sensors, applications, and/or data source devices, such as described herein. The TMC 128 also can collect task-related data from the users, the communication devices, VAs, applications, data source devices, supervisors or employers of users, clients of employers or users, and/or other data sources. Based at least in part on the results of the analysis (e.g., which can include AI-based analysis) of such information and observation, the TMC 128 (e.g., the task organizer component 204 of the TMC 128) can set respective tasks for respective users (e.g., can assign respective tasks to the respective users, and/or determine and set respective attributes associated with the respective tasks assigned to the respective users), in accordance with the defined task management criteria, such as described herein.

As indicated at reference numerals 404 and 406 of the task management flow 400, the TMC 128 can assess the performance of the users (e.g., users 108, 110, and/or 112) in performing their respective tasks, and the responses from the users and/or the other information collected relating to the users, tasks, and/or work environments, such as described herein. For instance, based at least in part on analysis of the collected information, the TMC 128 (e.g., the task organizer component 204, AI component 206, expertise component 210, or other component of the TMC 128) can determine, learn, or measure respective progress across respective tasks of respective users (e.g., users 108, 110, and/or 112) to determine or learn respective levels of expertise (e.g., levels of mastery) of the respective users across the respective tasks. The TMC 128 also can label tasks as short term or long term (or with another desired label, identifier, or tag) based at least in part on the analysis (e.g., AI-based analysis) and assessment of the collected information, including the user-provided feedback information relating to respective priorities of respective tasks. The TMC 128 also can determine and provide multiple objectives relating to the users (e.g., users 108, 110, and/or 112) and tasks to optimize against based at least in part on the analysis and assessment of the collected information, wherein the objectives can include respective objectives desired to be achieved by performing the respective tasks and/or respective objectives of or associated with the respective users.

As indicated at reference numerals 408 and 410 of the task management flow 400, the TMC 128 can adaptively adjust, reorganize, and/or reprioritize tasks (e.g., adjust, reorganize, and/or reprioritize assignments of tasks to users, sequence of performance of tasks, priorities of tasks, or other attributes associated with the tasks) based at least in part on the analysis (e.g., AI-based analysis) and assessment of the performance of the users and the information relating to the users (e.g., users 108, 110, and/or 112), tasks, or work environments, the labels assigned to tasks, and/or the user-provided feedback information, in accordance with the defined task management criteria, such as more fully described herein. The TMC 128 also can allow the learning of new tasks (e.g., personal or leisure tasks) by users (e.g., users 108, 110, and/or 112) during their personal (e.g., leisure or relaxation) time based at least in part on the user-provided feedback information and/or the TMC-identified or learned professional or personal goals of the users based at least in part on the observation of the users and the analysis or assessment of the collected information or the exploration/exploitation scheme and techniques (e.g., utilizing the exploration component 212), such as described herein. The TMC 128 also can determine or learn about the level of task completion achieved by a user based at least in part on historical data relating to work performed on tasks by the user and/or user-provided feedback information, wherein, if and as desired, the TMC 128 can present (e.g., periodically or dynamically present) questions to the user about the activity logs relating to tasks or other activities associated with the user.

In certain embodiments, the TMC 128 (e.g., the task organizer component 204 and/or AI component 206) can determine or learn desirable partitioning (e.g., breaking down) of a task (e.g., a task for achieving an overall or over-arching goal or result) into sub-tasks, such as a sequence (e.g., a sequential list) of desirable (e.g., suitable, successful, or optimal) sub-tasks by federated reinforcement learning across the users (e.g., users 108, 110, and/or 112) based at least in part on the analysis of the collected information and/or user-provided feedback information. In some embodiments, the TMC 128 can determine or learn a desirable (e.g., most efficient or beneficial, favorable, improved, or optimal) way (e.g., technique or process) for performing and completing of tasks based at least in part on the analysis of the collected information, including the user-provided feedback information, and/or the observation of the users (e.g., users 108, 110, and/or 112), such as described herein. The TMC 128 also can adaptively adjust attributes associated with tasks to be performed (e.g., executed) to account for external factors (e.g., work environments of users, or other external factor) based at least in part on analysis of the collected information (e.g., user-provided feedback information, environmental information obtained from sensors (e.g., sensors 122, 124, and/or 126), or other information).

In other embodiments, the TMC 128 (e.g., task organizer component 204 or AI component 206) can estimate, learn, or predict respective amounts of time (e.g., number of hours) that a particular user (e.g., user 108) has to put in (e.g., by work or education/learning) to attain one or more respective levels of expertise with regard to performing one or more respective tasks, based at least in part on the analysis of the collected information, while constraining for compulsory (e.g., compulsory work) or personal tasks separately. For instance, based at least in part on the analysis of such collected information, the TMC 128 can track the pace of accomplishment of the user with regard to performance of a task, and can predict or determine the level of expertise the user can attain in the future performance of that task or a similar task at a certain future point in time. In certain embodiments, based at least in part on the analysis of the collected information, the TMC 128 can determine and allocate respective amounts of time for users (e.g., users 108, 110, and/or 112) to perform respective tasks by optimizing on respective expertise levels of respective users across the respective tasks, while constraining for compulsory or personal tasks separately.

As indicated at reference numeral 412 of the task management flow 400, the TMC 128 can monitor and determine biometric/health metrics of users (e.g., users 108, 110, and/or 112), based at least in part on the analysis of the collected information, such as sensor information (e.g., obtained from biometric sensors 122, 124, and/or 126) and/or the user-provided feedback information relating to biometrics/health of the users, to provide feedback to the users to have them adjust (e.g., alter, omit, or slow down on) performance of tasks and/or allow time (e.g., time during the day) for the users to relax and recover, for example, if the TMC 128 detects that a user is experiencing stress, fatigue, illness, and/or potential injury. The TMC 128 can determine and facilitate implementing accommodations for integration of tasks (e.g., work tasks) with family time of users and coordination with other social activities of users to enable users to have a desirable work and life balance. As indicated at reference numeral 414 and reference numeral 410 of the task management flow 400, the TMC 128 can adaptively adjust, reorganize, and/or reprioritize tasks (e.g., assignments of tasks to users, sequence of performance of tasks, priorities of tasks), based at least in part on the monitoring and determining of biometric/health metrics of users, as such adaptive adjusting, reorganizing, and/or reprioritizing of tasks is determined to be desirable (e.g., favorable, suitable, useful, or optimal) by the TMC 128, in accordance with the defined task management criteria, such as more fully described herein.

As indicated at reference numeral 416 and reference numeral 410 of the task management flow 400, the TMC 128 can perform group-based task allocation, including adaptively recommending respective task schedules to respective users based at least in part on respective performance metrics determined (e.g., by the TMC 128) for the respective users, negotiation of recommended task schedules with the users, and adaptively adjusting, reorganizing, and/or reprioritizing tasks (e.g., assignments of tasks to users, sequence of performance of tasks, or allocations of time to perform tasks), based at least in part on the respective recommended task schedules, results of the respective negotiations with the respective users, and/or other factors, such as described herein. With regard to a recommended task schedule of a user (e.g., user 108), the TMC 128 can allow the user to override (to some extent) the scheduling of one or more tasks in the recommended task schedule based at least in part on a personal modification of a scheduling of a task(s) (e.g., via user-provided feedback information) received from the user via an interface(s) of the TMC 128, communication device (e.g., 102), or VA (e.g., 116), for example, when such requested schedule modification is in accordance with the defined task management criteria. The TMC 128, via an interface(s) of the TMC 128, communication device (e.g., 102), or VA (e.g., 116), can interact with the user (e.g., 108) to negotiate with the user with regard to the scheduling of one or more tasks (e.g., assignment of a task, amount of time allocated to complete a task, sequence of tasks, instructions for performing a task, or other scheduling-related aspect regarding a task), wherein the TMC 128, via the interface(s), can allow some negotiation regarding task scheduling and attempt to nudge the user towards a desirable agreement or resolution with regard to the scheduling of tasks of the user, such as described herein. The VA (e.g., VA 116, as managed or directed by the TMC 128) can utilize different VA personalities, virtual voices, wording, or other VA attributes to attempt to nudge (e.g., push) a user to desirably compromise and agree with regard to task scheduling, in response to different contexts associated with different users or tasks, such as described herein. For instance, the TMC 128 can adjust or facilitate adjusting VA attributes, such as a VA personality, of the VA (e.g., 116) to adjust the amount of pushiness and negotiation (e.g., of a negotiation strategy) that the VA will do in negotiating a modification to the task schedule that the user (e.g., 108) is requesting depending on how effective the pushiness and/or negotiation strategy is determined to be, or is predicted to be, by the TMC 128, based at least in part on the analysis of information relating to the interaction between the user and the VA (and TMC 128).

In some embodiments, the TMC 128 can adaptively determine or adjust the respective output information, comprising the respective task schedules, of respective users (e.g., users 108, 110, and/or 112) in a manner that is determined to allow the respective users to desirably (e.g., most quickly, suitably, efficiently, or optimally) receive and digest (e.g., understand or comprehend) the output information. In certain embodiments, the TMC 128 can determine and implement a desirable format for presenting information, such as task schedule-related information, to a user (e.g., 108), wherein the formats for presenting such information can comprise or relate to a calendar (e.g., electronic calendar), checkups (e.g., checkup on progress on tasks), and/or motivational updates to motivate a user to desirably perform and complete tasks. For instance, the TMC 128 (e.g., employing the task organizer component 204, notification component 208, schedule component 214, or other component of the TMC 128) can present (e.g., communicate) or facilitate presenting visual, audio, or haptic cues or prompts (e.g., visual, audio, or haptic notifications, reminders, flashes, annoyances, or other indicators), via an interface(s) of the TMC 128, communication device (e.g., 102), or VA (e.g., 116), that can, or at least can be intended to, get the attention of the user with regard to tasks or other information (e.g., motivational updates or prompts, task instructions, schedule changes, or rewards) relating to tasks to facilitate providing the user with task schedule-related information or updates to prompt or motivate the user to give desired attention to the task schedule-related information or updates and perform the tasks in a desired manner.

The TMC 128 and the techniques, functions, applications, and processes described herein can provide a number of benefits and advantages over existing systems, techniques, functions, and processes relating to task management. For instance, the TMC 128 and the techniques, functions, applications, and processes described herein can increase work performance efficiency of users in the performance of tasks with adjustments for varying levels of target functionalities for work and personal tasks of users. The TMC 128 and the techniques, functions, applications, and processes described herein can enable learning of new skills by users in a desirably steady-paced, sustainable, and efficient manner, while receiving feedback on progress of users in performing tasks in relation to (e.g., in comparison to) their prior performance on those tasks or similar tasks, or in relation to the performance of other users in the performance of those tasks or similar tasks. The TMC 128 and the techniques, functions, applications, and processes described herein also can enable the development of multi-tasking ability of users. The TMC 128 and the techniques, functions, applications, and processes described herein further can reduce stress or fatigue of users, and increase alertness of users, when performing tasks, as the TMC 128 can assess and determine the stress, fatigue, or alertness of users, as well as the capacity (e.g., work task-related capacity) of users, and can adjust and enhance work policies, including the scheduling of tasks of users, to facilitate preventing or mitigating overworking of users, and enhance mental and physical health conditions of users. The TMC 128 also can enable and facilitate enhanced and effective communication among users to improve the workflow of users as a group with regard to group-based tasks or in the overall performance of a business or other enterprise or organization. The TMC 128 and the techniques, functions, applications, and processes described herein also can allow for variation of use of the application program by users to exit the application program, if desired, and also keep a user engaged depending on the level of commitment desired with respect to tasks.

The disclosed subject matter, including the TMC 128 and the techniques, functions, applications, and processes described herein, can be useful in a variety of ways. For example, the disclosed subject matter can be used by students to assess and enhance their efficiency in work patterns, which can reduce student-life (e.g., graduate-life) stress. The disclosed subject matter, by desirably scheduling tasks for a user, but also allowing for adjustment of the task schedule of user, can be utilized to desirably (e.g., suitably or enhancedly) balance the flexibility of regular lifestyle with structure to adaptively adjust the user's daily task schedule based at least in part on user-constraints.

The disclosed subject matter can be utilized by companies to manage and distribute work deliverables for employees to maintain a healthy work environment. For instance, the disclosed subject matter can be utilized by a company to determine (e.g., calculate) the number of work hours desired (e.g., wanted or needed) for completion of a task, assess productivity across the company and its employees, and assess and determine a desirable work-life balance for its employees, such as described herein. For example, the disclosed subject matter can be utilized by a company to determine whether a four-day work week can lead to better quality of work-life balance and/or worker productivity to accomplish the same task in a shorter time span. Also, the disclosed subject matter can be utilized by the company to determine and provide suggestions about employee activity that can enable employees to maintain a healthy lifestyle while attaining a desirable (e.g., at least a minimal or suitable) level of expertise in their performance of tasks, such as described herein.

The disclosed subject matter can determine and/or provide (e.g., present) entertainment and personalized rewards, such as electronic badges (e.g., task completed electronic badges), financial rewards, or other rewards, to users (e.g., employees) to give users positive feedback and motivate the users to perform their tasks and utilize the application associated with the TMC 128, such as described herein. For example, the TMC 128 and associated application can be utilized to present a user a badge as a reward when the user completes all of the user's scheduled tasks (e.g., scheduled daily tasks) in one day, such as described herein. As another example, the TMC 128 and associated application can be utilized for personalized rewards, where the user may set a reward to treat himself or herself to a nice dinner at a nice restaurant if the user accomplishes successfully completing an online class or increases a level of expertise with regard to a particular type of task or group of tasks, such as described herein.

The disclosed subject matter also can be utilized to enable a user to learn new tasks based at least in part on the varying levels of hierarchical capability of the user, as determined or detected by the TMC 128 and associated application, or user-suggested next-stage goals in the professional or personal capacity of the user, such as described herein. For example, the TMC 128 and associated application can be utilized by a user (e.g., data scientist) to learn cloud-based architecture during the leisure time of the user, and/or for achieving personal goals, such as learning a new hobby, like playing a musical instrument (e.g., piano, guitar, drums, or saxophone). The disclosed subject matter also can be utilized in a variety of other ways to desirably manage scheduling and performance of tasks by users, improve productivity of users and an associated company, improve skills of users with regard to a variety of tasks, improve work-life balance of users, and maintain or improve physical and mental health of users, including the variety of ways described herein as well as other ways that can be contemplated with the disclosed subject matter.

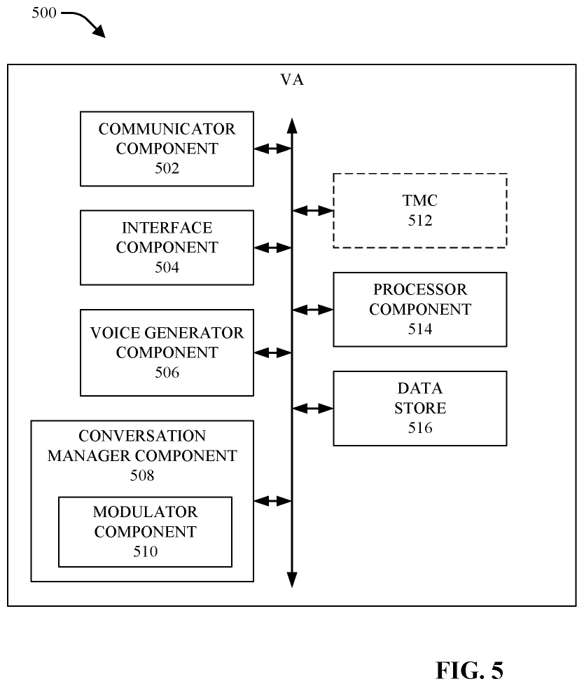

FIG. 5 illustrates a block diagram of an example VA 500, in accordance with various aspects and embodiments of the disclosed subject matter. The VA 500 can comprise, for example, a communicator component 502, an interface component 504, a voice generator component 506, a conversation manager component 508, and a modulator component 510. In some embodiments, the VA 500 can comprise (e.g., optionally can include) a TMC 512. The VA 500 can be the same as or similar to, and/or can comprise the same or similar functionality as, any of the VAs, as described herein (and vice versa). In certain embodiments, the VA 500 also can comprise a processor component 514 and data store 516.

The communicator component 502 can transmit information from the VA 500 to a user(s), or a component(s) or device(s) (e.g., another VA, a communication device, a TMC, a network component or device, or other component or device) and/or can receive information from the user, other component(s), or device(s), such as described herein.

The interface component 504 can comprise one or more interfaces, such as, for example, a display screen (e.g., touch display screen), an audio interface (e.g., microphone(s), speaker(s)), keyboard, keypad, controls, buttons, and/or other interface, that can be used to present information to a user associated with the VA 500 or receive information from the user, or a component(s) or device(s) (e.g., another VA, a communication device, a TMC, a network component or device, or other component or device), such as information that is input or communicated to the VA 500 by the user or the component(s) or the device(s). The VA 500 can interact with and have a conversation with the user by using the speaker(s) of the interface component 504 to present verbal words to the user, and the VA 500 can receive, via a microphone(s) of the interface component 504, verbal words spoken by the user. As another example, the user can view information (e.g., information relating to the interaction or event) displayed on the display screen of the interface component 504.

The voice generator component 506 can generate one or more voices of the VA 500 for use in communicating (e.g., speaking) verbal words and sounds that can be emitted from the VA 500 via the interface component 504 and/or communicator component 502. A voice generated by the voice generator component 506 can be a virtual or emulated voice that can emulate, mimic, recreate, or sound similar to the actual voice of a human being. The voice can have various characteristics (e.g., word speed, speech cadence, inflection, tone, language, dialect, vocabulary level, or other characteristic) that can define or structure the voice and the speaking (e.g., virtual or emulated speaking) of verbal words by the voice generator component 506.

The conversation manager component 508 can manage (e.g., control, modify, or adjust) the voice (e.g., the characteristics of the virtual or emulated voice) and the emission (e.g., speaking) of verbal words by the voice generator component 506 to facilitate managing a conversation with a user (or another VA or device) based at least in part on sentiment and personality attributes of the user, the context of the user or context of the interaction with the user (or other VA or device), including the verbal words spoken, and the characteristics of the verbal words spoken, by the user (or other VA or device) during the conversation, the environmental conditions associated with the user, and/or the VA personality attributes of the VA 500. The conversation manager component 508 also can determine and manage the verbal words to be emitted by the voice generator component 506 during the conversation, based at least in part on information or instructions relating to the conversation or interaction received from a TMC, the sentiment and personality attributes of the user, the context of the user or the interaction, including what was said to the VA 500 by the user (or other VA or device) participating in the conversation, the environmental conditions associated with the user, and/or the VA personality attributes of the VA 500. For example, based at least in part on the information or instructions relating to the conversation or interaction received from a TMC, the sentiment and personality attributes of the user, the context, the environmental conditions, and/or the VA personality attributes, the conversation manager component 508 (e.g., in coordination with, or as managed by, the TMC) can determine a question to ask or a statement to make to the user (or other VA or device) next in a conversation, a response to a question or statement made by the user or other VA to the VA 500, or other conversation to have with the user (or other VA or device). The conversation manager component 508 can coordinate with, be managed by, and/or operate in conjunction with the TMC to facilitate managing the personality, voice, or other characteristics of the VA 500, the determination of verbal words to be emitted, the emission of verbal words, and the overall conversing by the voice generator component 506, based at least in part on the sentiment and personality attributes of the user, the context, the environmental conditions, and/or the VA personality attributes, in accordance with the defined task management criteria.

The conversation manager component 508 can comprise a modulator component 510 that can be utilized to modulate or adjust the voice, including adjusting the characteristics of the voice, produced by the voice generator component 506. For example, based at least in part on the sentiment and personality attributes of the user, the context, the environmental conditions, and/or the VA personality attributes, the modulator component 510 can adjust (e.g., increase or decrease) the speed and/or cadence of the verbal words emitted by the voice generator component 506, the inflection and/or tone of the voice and/or verbal words emitted by the voice generator component 506, the language and/or dialect of the verbal words emitted by the voice generator component 506, the vocabulary level of the verbal words emitted by the voice generator component 506, the syntax of the conversation, and/or one or more other characteristics of the voice or verbal words to facilitate producing verbal words that can enhance the flow of the conversation and enhance the productivity and results of the conversation and interaction with the user (or VA or other device).

In some embodiments, the VA 500 can comprise (e.g., optionally can comprise) the TMC 512 that can control the VA 500 during an interaction between the VA 500 and a user, another VA, or another device or component, as more fully described herein. In other embodiments, the TMC can be separate from, but associated with (e.g., communicatively connected to), the VA 500 to control the VA 500 during an interaction between the VA 500 and a user, another VA, or another device or component, such as more fully described herein. In certain embodiments, even if the VA 500 does not include all of the components of the TMC, the VA 500 can comprise certain desired components (e.g., task organizer component, AI component, notification component, expertise component, exploration component, schedule component, and/or other component) and associated functionality of the TMC.

The processor component 514 can work in conjunction with the other components (e.g., communicator component 502, interface component 504, voice generator component 506, conversation manager component 508, modulator component 510, TMC 512, and/or data store 516) to facilitate performing the various functions of the VA 500. The processor component 514 can employ one or more processors, microprocessors, or controllers that can process data, such as information relating to users, VAs, communication devices or other devices, interactions, events, contexts associated with users, tasks, or interactions, status or progress of tasks, status or progress of interactions associated with users, demographic data, data privacy, activities relating to interactions, environmental conditions associated with users, tasks, or interactions, identifiers or authentication credentials associated with users, entities, devices, or components, updates to user profiles of users, parameters, traffic flows, policies, defined task management criteria, algorithms (e.g., task management algorithm(s), AI-based algorithms, or other algorithms), protocols, interfaces, tools, and/or other information, to facilitate operation of the VA 500, as more fully disclosed herein, and control data flow between the VA 500 and other components (e.g., other VAs, communication devices, base stations, network devices of the communication network, data sources, applications, or other component or device) associated with the VA 500.

The data store 516 can store data structures (e.g., user data, metadata), code structure(s) (e.g., modules, objects, hashes, classes, procedures) or instructions, information relating to users, VAs, communication devices or other devices, interactions, events, contexts associated with users, tasks, or interactions, status or progress of tasks, status or progress of interactions associated with users, demographic data, data privacy, activities relating to interactions, environmental conditions associated with users, tasks, or interactions, identifiers or authentication credentials associated with users, entities, devices, or components, updates to user profiles of users, parameters, traffic flows, policies, defined task management criteria, algorithms (e.g., task management algorithm(s), AI-based algorithms, or other algorithms), protocols, interfaces, tools, and/or other information, to facilitate controlling operations associated with the VA 500. In an aspect, the processor component 514 can be functionally coupled (e.g., through a memory bus) to the data store 516 in order to store and retrieve information desired to operate and/or confer functionality, at least in part, to the communicator component 502, interface component 504, voice generator component 506, conversation manager component 508, modulator component 510, TMC 512, processor component 514, data store 516, or other component, and/or substantially any other operational aspects of the VA 500.

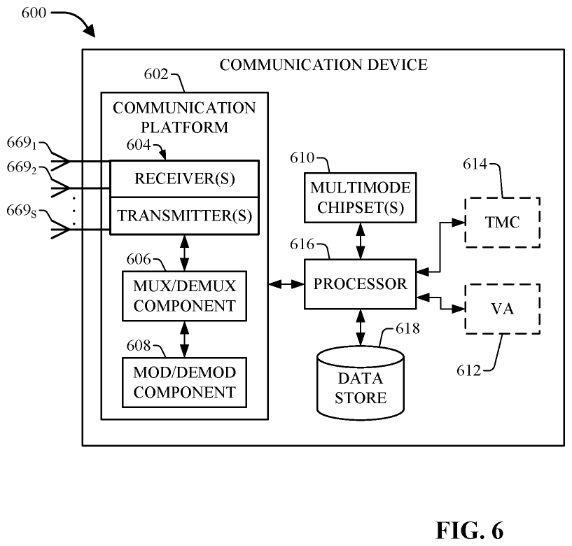

FIG. 6 depicts a block diagram of an example communication device 600 (e.g., communication device) in accordance with various aspects and embodiments of the disclosed subject matter. In accordance with various embodiments, the communication device 600 (e.g., communication device) can be a multimode access terminal, wherein a set of antennas 669₁-669_{S} (wherein S can be a positive integer) can receive and transmit signal(s) from and to wireless devices like access points, access terminals, wireless ports and routers, and so forth, that operate in a radio access network. It should be appreciated that antennas 669₁-669_{S} can be a part of communication platform 602, which comprises electronic components and associated circuitry that provide for processing and manipulation of received signal(s) and signal(s) to be transmitted; e.g., receivers and transmitters 604, multiplexer/demultiplexer (mux/demux) component 606, and modulation/demodulation (mod/demod) component 608.

In some implementations, the communication device 600 can include a multimode operation chipset(s) 610 that can allow the communication device 600 to operate in multiple communication modes in accordance with disparate technical specification for wireless technologies. In an aspect, multimode operation chipset(s) 610 can utilize communication platform 602 in accordance with a specific mode of operation (e.g., voice, global positioning system (GPS), or other mode of operation). In another aspect, multimode operation chipset(s) 610 can be scheduled to operate concurrently (e.g., when S>1) in various modes or within a multitask paradigm.

In certain embodiments, the communication device 600 also can comprise (e.g., optionally can comprise or implement) a VA 612 that can interact with a user, perform services for, and/or perform functions or tasks for or on behalf of, the user, as more fully described herein. The VA 612 can comprise the same or similar functionality as more fully described herein with regard to other systems or methods disclosed herein.

In some embodiments, the communication device 600 also can comprise (e.g., optionally can comprise or implement) a TMC 614 that can manage performance of tasks by or associated with users, including adaptively adjusting attributes associated with tasks, to facilitate desirable (e.g., favorable, efficient, improved, or optimal) workflow management, in accordance with various aspects and embodiments of the disclosed subject matter, as more fully described herein. The TMC 614 can comprise the same or similar functionality as more fully described herein with regard to other systems or methods disclosed herein.

The communication device 600 also can include a processor(s) 616 that can be configured to confer functionality, at least in part, to substantially any electronic component within the communication device 600, in accordance with aspects of the disclosed subject matter. For example, the processor(s) 616 can facilitate enabling the communication device 600 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 616 can facilitate enabling the communication device 600 to process data relating to messaging, voice calls, or other services (e.g., Internet services or access); information relating to measurements of signal conditions with respect to cells; information relating to cells to facilitate connection to a source cell or target cell; information relating to parameters (e.g., communication device parameters, network-related parameters); information relating to interactions between the communication device 500 and other devices or components (e.g., VA, another communication device), as more fully described herein; and/or other data. In certain embodiments, the processor(s) 616 can process data to facilitate implementing the VA 612 and/or TMC 614, and/or facilitate enabling the VA 612 and/or TMC 614 to interact with a user, perform services for, and/or perform functions or tasks for or on behalf of, the user, as more fully described herein.

The communication device 600 also can contain a data store 618 that can store data structures (e.g., user data, metadata); code structure(s) (e.g., modules, objects, classes, procedures) or instructions; message hashes; neighbor cell list; one or more lists (e.g., whitelist, etc.); information relating to measurements of signal conditions with respect to cells; information relating to cells to facilitate connection to a source cell or target cell; information relating to parameters (e.g., communication device parameters, network-related parameters); information relating to interactions between the communication device 600 and other devices or components (e.g., VA, TMC, or another communication device); communication device identifier; information relating to voice calls, messaging, or other services associated with the communication device 600; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In certain embodiments, the data store 618 can store data relating to the VA 612 to facilitate implementing the VA 612 and/or facilitate enabling the VA 612 to interact with a user, perform services for, and/or perform functions or tasks for or on behalf of, the user, as more fully described herein. In some embodiments, the data store 618 can store data relating to the TMC 614 to facilitate implementing the TMC 614 and/or facilitate enabling the TMC 614 to interact with a user, perform services for, and/or perform functions or tasks for or on behalf of, the user, as more fully described herein. In an aspect, the processor(s) 616 can be functionally coupled (e.g., through a memory bus) to the data store 618 in order to store and retrieve information (e.g., neighbor cell list; signal quality measurement-related information; cell-related information; parameter information; information relating to messaging, voice calls, or other services (e.g., interactive services); information relating to interactions; frequency offsets; desired algorithms; security code; communication device identifier), VA-related data, and/or TMC-related data that can be desired to operate and/or confer functionality, at least in part, to communication platform 602, multimode operation chipset(s) 610, the VA 612, TMC 614, and/or substantially any other operational aspects of the communication device 600.

It is to be appreciated and understood that the machine (e.g., computer) processing systems, machine-implemented methods, apparatus, and/or machine program products described herein can employ hardware and/or software to solve problems that can be highly technical in nature (e.g., the management and adaptive adjustment of scheduling of tasks to be performed by users based on a variety of inputs, including task-related information that can be obtained from a variety of sources, feedback information from users, biometric information associated with users that can be obtained from a number of sensors and other devices, and/or other data sources), that are not abstract and cannot be performed as a set of mental acts by a human. For example, an individual, or a plurality of individuals, cannot readily and/or efficiently network, interact, and communicate with a variety of data sources (e.g., in real time or near real time), such as communication devices, VAs, sensors, IoTs, other devices, and/or users, as inputs of information (e.g., task-related information, feedback information from users, biometric information associated with users, and/or other information) that can be analyzed (e.g., in real time or near real time) to facilitate managing and adaptively adjusting scheduling of tasks for users.

Also, one or more embodiments described herein can constitute a technical improvement over existing techniques, systems, methods, and applications for managing tasks and users in the performance of tasks. Additionally, various embodiments described herein can demonstrate a technical improvement over existing techniques, systems, methods, and applications, for example, by reducing latency and enhancing efficiency of computer-based applications and computer-based resources with regard to managing and adaptively adjusting scheduling of tasks for users, by enhancing interfaces for use by users and other devices, and by having the capability of networking, interacting, and communicating with a variety of data sources (e.g., in real time or near real time), such as communication devices, VAs, sensors, IoTs, other devices, and/or users, as inputs of information (e.g., task-related information, feedback information from users, biometric information associated with users, and/or other information) that can be analyzed to facilitate managing and adaptively adjusting scheduling of tasks for users. Further, one or more embodiments described herein can have a practical application by desirably (e.g., suitably, enhancedly, or optimally) managing and adaptively adjusting scheduling of tasks for users (e.g., in real time or near real time).

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

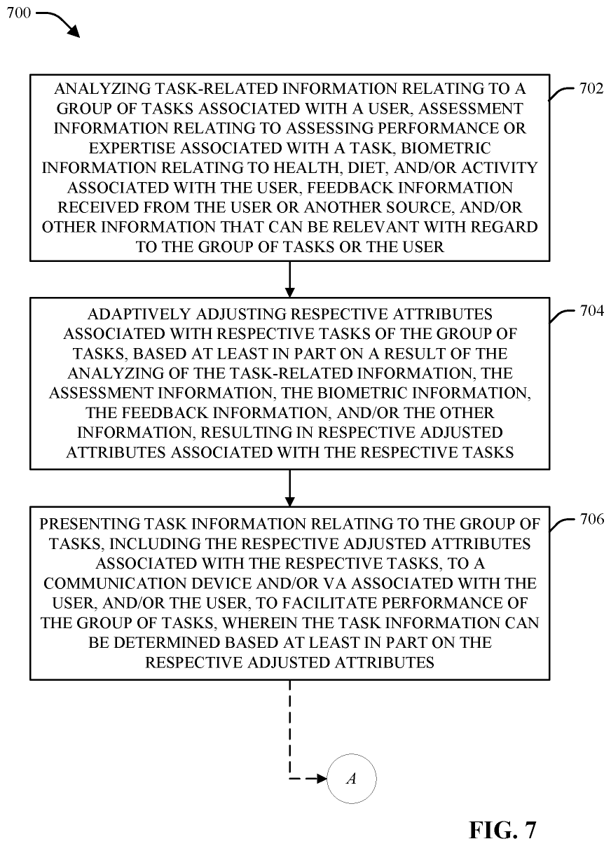

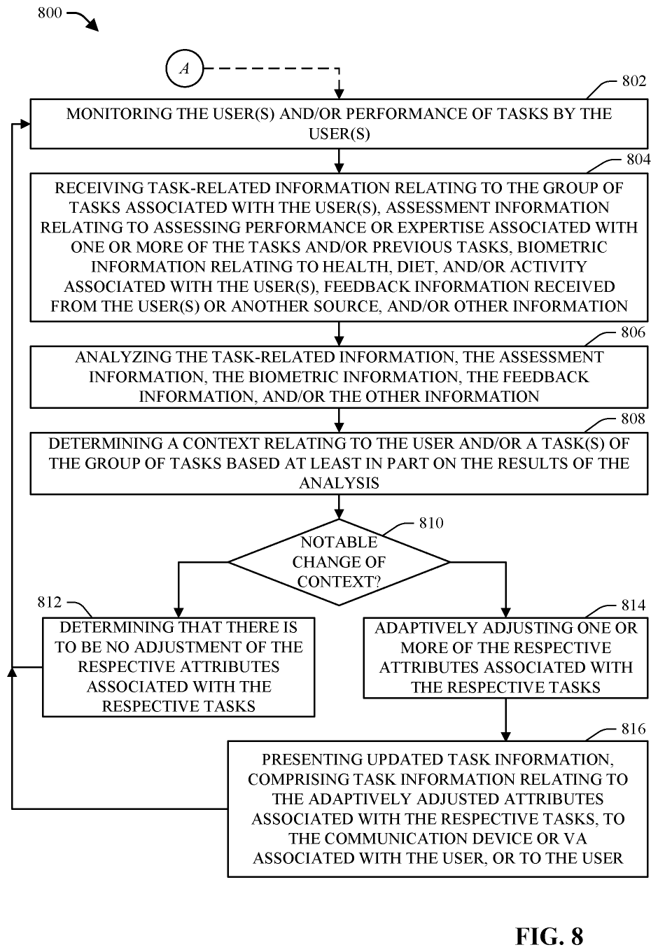

In view of the example systems and/or devices described herein, example methods that can be implemented in accordance with the disclosed subject matter can be further appreciated with reference to flowcharts in FIGS. 7-8. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a diagram of a flow chart of an example method 700 that can manage performance of tasks by or associated with a user to facilitate desirable workflow management, in accordance with various aspects and embodiments of the disclosed subject matter. The method 700 can be employed by, for example, a system comprising the TMC and/or the VA, a processor component (e.g., of or associated with the TMC and/or the VA), and/or a data store (e.g., of or associated with the TMC and/or the VA).

At 702, task-related information relating to a group of tasks associated with a user, assessment information relating to assessing performance or expertise associated with a task, biometric information relating to health, diet, and/or activity associated with the user, feedback information received from the user or another source, and/or other information that can be relevant with regard to the group of tasks or the user can be analyzed. The TMC can analyze the task-related information, the assessment information, the biometric information, the feedback information, and/or the other information, such as described herein. The feedback information and/or other information can relate to one or more of the tasks, and/or the health, diet, and/or activity associated with the user. In certain embodiments, the feedback information and/or other information can be received from and/or can relate to the user and/or other users with regard to performance of a task(s) of the group of tasks (e.g., the level of experience or expertise of the user or other user(s) with regard to performing the task or a similar task, how to desirably (e.g., efficiently, appropriately, or optimally) perform the task or a similar task, and/or previous performance outcomes of performance of the task or a similar task by the user and/or other user(s)).

In some embodiments, as part of the analysis, the TMC can perform an AI-based analysis on the task-related information, the assessment information, the biometric information, the feedback information, and/or the other information. The AI-based analysis can comprise utilizing or applying AI, ML, models, neural networks, functions, and/or other AI-based techniques and algorithms on such information, such as described herein.

At 704, respective attributes associated with respective tasks of the group of tasks can be adaptively adjusted, based at least in part on a result of the analyzing of the task-related information, the assessment information, the biometric information, the feedback information, and/or the other information, resulting in respective adjusted attributes associated with the respective tasks. The TMC can adaptively adjust (e.g., modify, alter, or change) the respective attributes (e.g., properties, elements, or characteristics) associated with the respective tasks based at least in part on the analysis results.

At 706, task information relating to the group of tasks, including the respective adjusted attributes associated with the respective tasks, can be presented to a communication device and/or VA associated with the user, and/or the user, to facilitate performance of the group of tasks, wherein the task information can be determined based at least in part on the respective adjusted attributes. The TMC can determine the task information based at least in part on the respective adjusted attributes associated with the respective tasks. The TMC can present (e.g., communicate, emit, display, or otherwise present) the task information relating to the respective tasks, which can include information relating to the respective adjusted attributes, to the communication device, VA, and/or user, to facilitate performance of the group of tasks (e.g., by the user). The task information can indicate the respective tasks to be performed, how to perform the respective tasks, a schedule indicating respective dates/times for performance of the respective tasks, respective amounts of time allocated for performance of the respective tasks, resources available to facilitate performance of the respective tasks, and/or other task information, such as described herein.

In some embodiments, the method 700 can proceed to reference point A, wherein method 800 of FIG. 8 can proceed from reference point A, as described herein.

FIG. 8 illustrates a diagram of a flow chart of an example method 800 that can monitor the user(s) and performance of tasks by the user(s) to manage performance of tasks by or associated with the user(s), including adaptively adjusting attributes associated with tasks, to facilitate desirable workflow management, in accordance with various aspects and embodiments of the disclosed subject matter. The method 800 can be employed by, for example, a system comprising a system comprising the TMC and/or the VA, a processor component (e.g., of or associated with the TMC and/or the VA), and/or a data store (e.g., of or associated with the TMC and/or the VA). In some embodiments, the method 800 can proceed from reference point A, where the method 700 of FIG. 7 had ended.

At 802, the user(s) and/or performance of tasks by the user(s) can be monitored. The TMC can monitor the user and/or performance of tasks of the group of tasks by the user. The TMC also can monitor one or more other users and/or performance of other tasks by the one or more other users, wherein the other users may be performing tasks that can be same as or similar to the tasks being performed, or to be performed, by the user, or the other users may be collaborating with the user to perform tasks of the group of tasks. The monitoring of the user(s) and/or performance of tasks by the user(s) can include the TMC monitoring the environment(s) (e.g., work environment, social environment, home environment, outside environment, or other environment) associated with the user(s) and/or other user(s). The TMC can perform such monitoring via sensors (e.g., cameras, microphones, biometric sensors, environmental sensors, or other types of sensors) and/or feedback from users or devices, such as described herein.

At 804, task-related information relating to the group of tasks associated with the user(s), assessment information relating to assessing performance or expertise associated with one or more of the tasks and/or previous tasks, biometric information relating to health, diet, and/or activity associated with the user(s), feedback information received from the user(s) or another source, and/or other information that can be relevant with regard to the group of tasks or the user(s) can be received. Based at least in part on the monitoring, the TMC can receive the task-related information, the assessment information, the biometric information, the feedback information, and/or the other information (e.g., additional task-related information, assessment information, biometric information, feedback information, and/or other information) associated with the user(s) and/or the tasks, such as described herein. For instance, the TMC can receive sensor data from one or more sensors associated with the user that can be sensing or measuring biometric characteristics associated with the user, and/or sensor data from one or more sensors (e.g., environmental sensors) that can be sensing or measuring environmental characteristics of the environment associated with the user. Additionally or alternatively, the TMC can receive task performance data that can indicate how well the user is doing with regard to performing one or more of the tasks of the group of tasks, wherein the task performance data, for example, can indicate whether the user is having any difficulty in performing a task, can indicate a level of expertise a user is displaying in connection with performing a task, can indicate whether the user is performing and completing tasks in accordance with the task schedule (e.g., as indicated in the task information presented to the user), and/or can provide other indications relating to performance of tasks by the user(s).

At 806, the task-related information, the assessment information, the biometric information, the feedback information, and/or the other information can be analyzed. The TMC can analyze (which can include an AI-based analysis) the task-related information, the assessment information, the biometric information, the feedback information, and/or the other information, such as described herein. The feedback information and/or other information can relate to one or more of the tasks, and/or the health, diet, and/or activity associated with the user. In certain embodiments, the feedback information and/or other information can be received from and/or can relate to the user and/or other users with regard to performance of a task(s) of the group of tasks (e.g., the level of experience or expertise of the user and/or other user(s) with regard to performing the task or a similar task, how to desirably (e.g., efficiently, appropriately, or optimally) perform the task or a similar task, previous performance outcomes of performance of the task or a similar task by the user and/or other user(s), and/or physical or mental health, fatigue or stress levels, and/or diet or eating routine (e.g., eating schedule) associated with the user and/or other user(s).

At 808, a context relating to the user and/or a task(s) of the group of tasks can be determined based at least in part on the results of the analysis. The TMC can determine the context (e.g., current context) relating to the user and/or the task(s) based at least in part on the results of the analysis. The TMC also can analyze (e.g., compare) the context in relation to a previous context relating to the user and/or the task(s) to facilitate determining whether there has been a notable change (e.g., a significant, actionable, or threshold amount of change) of context relating to the user and/or the task(s).

At 810, based at least in part on the results of the analysis, the context, and the previous context, a determination can be made regarding whether there has been a notable change of context relating to the user and/or the task(s). The TMC can determine whether there has been a notable change of context (e.g., a significant, actionable, or threshold amount of change) relating to the user and/or the task(s), based at least in part on the results of the analysis, the context, and the previous context. For example, the TMC can determine whether a fatigue or stress level of the user has undesirably increased (e.g., relative to the previous fatigue or stress level associated with the previous context) such that the fatigue or stress level satisfies (e.g., meets or exceeds) the defined threshold fatigue or stress level. As another example, the TMC can determine whether the user has undesirably fallen behind in performing and/or completing the task (e.g., relative to the allocated or scheduled amount of time for the task associated with the previous context) such that the amount of time the user is behind schedule is determined to be significant and/or satisfies (e.g., meets or exceeds) the defined threshold amount of time relating to the task. As still another example, with regard to a task that the user is scheduled to perform, the TMC can determine whether there are improved instructions (e.g., relative to previous instructions) for performing the task as received or derived (e.g., derived by the TMC) from feedback information of another user(s) with respect to the task or a similar task and/or observance of the other user(s) performing the task or the similar task.

If it is determined that there has not been a notable change of context relating to the user and/or the task(s), at 812, it can be determined that no adjustment of the respective attributes associated with the respective tasks is to be made. If the TMC that there has not been a notable change of context relating to the user and/or the task(s), the TMC can determine that there is to be no adjustment made to the respective attributes associated with the respective tasks. In some embodiments, at this point, the method 800 can return to reference numeral 802, wherein the method 800 can proceed from reference numeral 802 to continue to monitor the user(s) and/or performance of tasks by the user(s).

Referring again to reference numeral 810, if, instead, at 810, it is determined that there has been a notable change of context relating to the user and/or the task(s), at 814, one or more of the respective attributes associated with the respective tasks can be adaptively adjusted based at least in part on the notable change of context and the analysis results. If the TMC determines that there has been a notable change of context relating to the user and/or the task(s), the TMC can determine one or more adjustments that can be made to one or more of the respective attributes associated with the respective tasks, and the one or more respective attributes can be adjusted (e.g., adaptively adjusted), based at least in part on the notable change of context and the analysis results. For example, if the TMC determines that the fatigue or stress level of the user has undesirably increased such that the fatigue or stress level satisfies the defined threshold fatigue or stress level, the TMC can adaptively adjust certain attributes associated with one or more of the remaining tasks to be performed by the user to try to reduce the fatigue or stress level of the user. For instance, the TMC can adjust scheduling of one or more of the remaining tasks to provide some recovery, relaxation, or leisure time to enable the user to relax and recover to reduce the fatigue or stress level of the user. While determining adjustments that can be made to certain attributes associated with one or more remaining tasks (e.g., adjusting scheduling of tasks and/or amount of time allocated to perform tasks), the TMC can take into account deadlines (e.g., hard or inflexible deadlines) for performing certain tasks to ensure that any adjustments made to task attributes can still enable the tasks to be timely and suitably completed in accordance with such deadlines and applicable task management criteria.

As another example, if the TMC determines that the user has undesirably fallen behind in performing and/or completing the task, the TMC can adaptively adjust certain attributes associated with the task and/or one or more of the other remaining tasks to be performed by the user to account for the user being behind schedule on performing or completing the task. For instance, the TMC can allocate additional time for the user to complete the task, and adjust the scheduling of one or more of the other remaining tasks and/or their allocated times for performance and completion, to try to create a suitable revised schedule for completion of the remaining tasks. Additionally or alternatively, the TMC can determine whether there are improved or alternate instructions for performing the task that the user can utilize to attempt to catch up time-wise in the performance and completion of the task and the other remaining tasks as well, and, if so, can adjust (e.g., adaptively adjust) an attribute(s) associated with the task, e.g., can adjust the instructions for performing the task.

At 816, updated task information, comprising task information relating to the adaptively adjusted attributes associated with the respective tasks, can be presented to the communication device or VA associated with the user, and/or to the user. The TMC can present (e.g., communicate, display, emit, or provide) the updated task information to the communication device, VA and/or user. The user can utilize, act on, or follow the updated task information in the performance of the task and/or the one or more other remaining tasks.

In some embodiments, at this point, the method 800 can return to reference numeral 802, wherein the method 800 can proceed from reference numeral 802 to continue to monitor the user(s) and/or performance of tasks by the user(s).

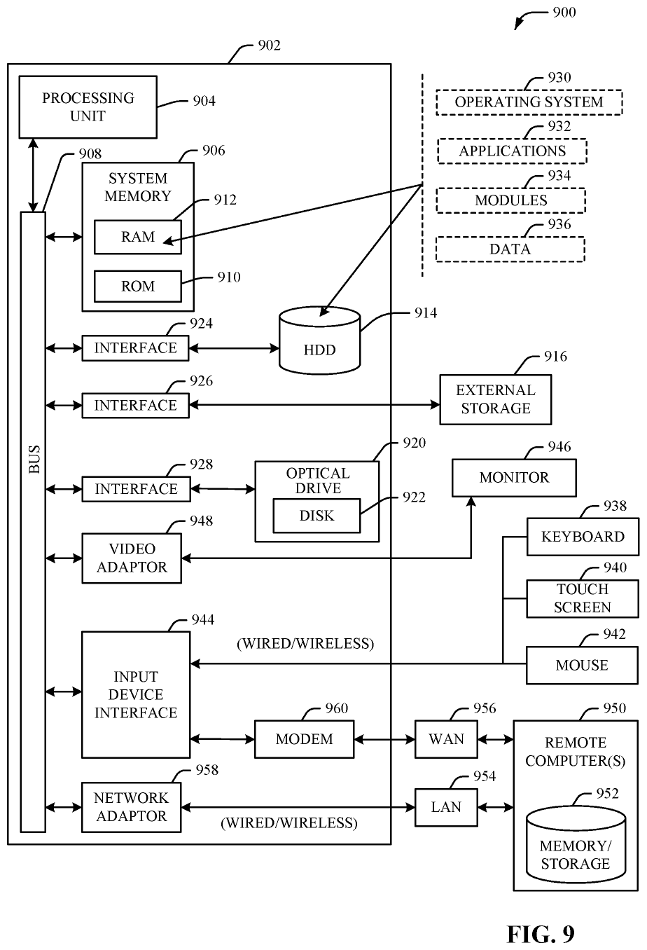

In order to provide additional context for various embodiments described herein, FIG. 9 and the following discussion are intended to provide a brief, general description of a suitable computing environment 900 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enable with a security module, such as a trusted processing module (TPM). For instance with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956, e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

It is to be noted that aspects, features, and/or advantages of the disclosed subject matter can be exploited in substantially any wireless telecommunication or radio technology, e.g., Wi-Fi; Gi-Fi; Hi-Fi; Bluetooth; worldwide interoperability for microwave access (WiMAX); enhanced general packet radio service (enhanced GPRS); third generation partnership project (3GPP) long term evolution (LTE); third generation partnership project 2 (3GPP2) ultra mobile broadband (UMB); 3GPP universal mobile telecommunication system (UMTS); high speed packet access (HSPA); high speed downlink packet access (HSDPA); high speed uplink packet access (HSUPA); GSM (global system for mobile communications) EDGE (enhanced data rates for GSM evolution) radio access network (GERAN); UMTS terrestrial radio access network (UTRAN); LTE advanced (LTE-A); Z-Wave; Zigbee; and other 802.XX wireless technologies and/or legacy telecommunication technologies. Additionally, some or all of the aspects described herein can be exploited in legacy telecommunication technologies, e.g., GSM. In addition, mobile as well non-mobile networks (e.g., the internet, data service network such as internet protocol television (IPTV), etc.) can exploit aspects or features described herein.

Wi-Fi, or Wireless Fidelity, can enable connection to the Internet from a couch at home, in a hotel room, or a conference room at work, without wires. Wi-Fi is a wireless technology similar to that used in a cell phone that can enable such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks can operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

As used in this disclosure, in some embodiments, the terms “component,” “system,” “interface,” and the like can refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

Various aspects or features described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field PGA (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component”, “system”, “platform”, “framework”, “layer”, “interface”, “agent”, and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

Terms like “user equipment” (UE), “mobile station,” “mobile,” “wireless device,” “wireless communication device,” “subscriber station,” “subscriber equipment,” “access terminal,” “terminal,” “handset,” and similar terminology, as used herein, can refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point” (AP), “base station,” “node B,” “evolved node B” (eNode B or eNB), “home node B” (HNB), “home access point” (HAP), and the like are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. Further, the terms “device,” “communication device,” “mobile device,” “entity,” and the like can be employed interchangeably throughout, unless context warrants particular distinctions among the terms.

Furthermore, the terms “user,” “entity,” “subscriber,” “customer,” “consumer,” “owner,” “agent,” and the like can be employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

The term “facilitate” as used herein is in the context of a system, device or component “facilitating” one or more actions or operations, in respect of the nature of complex computing environments in which multiple components and/or multiple devices can be involved in some computing operations. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, a VA, TMC, AI component, communication devices, processors, data stores, sensors, antennae, audio and/or visual output devices, or other devices.

It is to be appreciated and understood that components (e.g., communication device, VA, TMC, sensor, communication network, processor component, data store, or other component or device), as described with regard to a particular system or method, can include the same or similar functionality as respective components (e.g., respectively named components or similarly named components) as described with regard to other systems or methods disclosed herein.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What has been described above includes examples of systems, methods, and techniques that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
analyzing, by a system comprising a processor, task-related information relating to a group of tasks associated with a user identity, assessment information relating to assessing performance of a task, and biometric information relating to health, diet, and activity associated with the user identity;
adaptively adjusting, by the system, respective attributes of respective tasks of the group of tasks based on a result of the analyzing of the task-related information, the assessment information, and the biometric information, the adaptively adjusting resulting in respective adjusted attributes of the respective tasks; and
presenting, by the system, task information to a device associated with the user identity to facilitate performance of the group of tasks, wherein the task information is determined based on the respective adjusted attributes.

2. The method of claim 1, wherein the user identity is a first user identity, wherein the task is part of the group of tasks or is a previous task associated with the first user identity or a second user identity, and wherein the previous task is determined to be same as, or relevant with respect to, at least one task of the group of tasks, or wherein the previous task is determined to satisfy a defined task similarity criterion with respect to the at least one task.

3. The method of claim 1, wherein the group of tasks comprises the task, wherein the analyzing comprises performing an artificial intelligence-based analysis on the task-related information, the assessment information, the biometric information, or feedback information associated with the user identity and relating to the group of tasks, and wherein the method further comprises:
based on the artificial intelligence-based analysis, learning, by the system, a level of expertise associated with the user identity with respect to performance of the task, wherein the adaptively adjusting comprises adaptively adjusting an attribute of the task based on the level of expertise.

4. The method of claim 3, wherein the performing of the artificial intelligence-based analysis comprises performing the artificial intelligence-based analysis on information relating to respective levels of expertise associated with respective user identities with respect to the task and respective performance metrics associated with performance of the task or a similar task associated with the respective user identities, wherein the similar task is determined to satisfy a defined task similarity criterion with regard to the task, and wherein the method further comprises:
based on the artificial intelligence-based analysis, learning, by the system, respective differences between the level of expertise associated with the user identity and the respective levels of expertise associated with the respective user identities with respect to the task,
wherein the adaptively adjusting comprises adaptively adjusting the attribute of the task based on the respective differences between the level of expertise and the respective levels of expertise, and based on the respective performance metrics.

5. The method of claim 1, further comprising:
based on the analyzing and the adaptively adjusting, allocating, by the system, respective amounts of time for performance of the respective tasks or respective sub-tasks of the task associated with the user identity.

6. The method of claim 1, wherein the group of tasks comprises the task, and wherein the adaptively adjusting comprises adaptively adjusting an order, a sequence, or a schedule of the performance of the respective tasks, adaptively adjusting an amount of time allocated to perform the task, adaptively adjusting a priority level associated with the task, adaptively adjusting a determination regarding an amount of progress that has been made towards completion of the task, adaptively adjusting instructions that indicate how the task is to be performed, adaptively adjusting a reminder, notification, or motivation message relating to the task, adaptively adjusting calendar information relating to the task in an electronic calendar, or adaptively adjusting a reward that is to be presented in connection with completion of the task or the group of tasks.

7. The method of claim 1, wherein the task-related information is first task-related information, wherein the assessment information is first assessment information, wherein the biometric information is first biometric information, wherein the respective attributes are respective first attributes, wherein the result is a first result, and wherein the method further comprises:
subsequent to the adjusting of the respective first attributes of the respective tasks, receiving, by the system, feedback information associated with the user identity, second task-related information relating to the group of tasks associated with the user identity, second assessment information relating to assessing performance of the task, or second biometric information relating to the health, the diet, or the activity associated with the user identity, wherein the feedback information relates to the group of tasks, or the health, the diet, or the activity associated with the user identity;
analyzing, by the system, the feedback information, the second task-related information, the second assessment information, or the second biometric information;
adaptively adjusting, by the system, a second attribute or a portion of the respective first attributes of the respective tasks based on a second result of the analyzing of the feedback information, the second task-related information, the second assessment information, or the second biometric information; and
to facilitate adjusting the performance of a portion of the group of tasks, presenting, by the system, updated task information to the device, wherein the updated task information relates to, and is determined based on, the adaptively adjusting of the second attribute or the portion of the respective first attributes of the respective tasks.

8. The method of claim 1, further comprising:
monitoring, by the system, a health metric associated with the user identity;
based on the monitoring, receiving, by the system, a portion of the biometric information that relates to the health metric; and
determining, by the system, the health metric associated with the user identity based on the analyzing of the portion of the biometric information, wherein the adaptive adjusting comprises adaptively adjusting the respective attributes of the respective tasks based on the result of the analyzing of the task-related information, the assessment information, and the biometric information comprising the portion of the biometric information that relates to the health metric.

9. The method of claim 1, wherein the biometric information is first biometric information, wherein the respective attributes are respective first attributes, and wherein the method further comprises:
detecting, by the system, a fatigue level associated with the user identity based on analyzing second biometric information relating to the health, the diet, or the activity associated with the user identity;
in response to determining that the fatigue level exceeds a defined threshold fatigue level that indicates fatigue associated with the user identity is to be reduced, determining, by the system, a recovery time period associated with the user identity that enables a reduction of the fatigue associated with the user identity,
subsequent to the adjusting of the respective first attributes of the respective tasks, adaptively adjusting, by the system, a second attribute or a portion of the respective first attributes of the respective tasks associated with the user identity to accommodate the recovery time period, and wherein, to accommodate the recovery time period, none of the respective tasks that remain to be performed are scheduled to be performed during the recovery time period.

10. The method of claim 1, wherein the respective tasks comprise the task, and wherein the method further comprises:
in response to determining that the task associated with the user identity has been completed, determining, by the system, reward information relating to a reward to present to an account or an interface associated with the user identity based on a task type of the task that was completed, an amount of time utilized to complete the task, or a priority level associated with the task; and
presenting, by the system, the reward information to the account or the interface associated with the user identity.

11. The method of claim 1, further comprising:
receiving, by the system, sensor information from a group of sensors associated with the user identity, wherein the biometric information comprises the sensor information; and
receiving, by the system, priority information, relating to respective priority levels associated with the respective tasks, from the device associated with the user identity or a data source device, wherein the task-related information or the assessment information comprises the priority information, and
wherein the adaptively adjusting comprises adaptively adjusting the respective attributes of the respective tasks based on the result of the analyzing of the sensor information and the priority information.

12. The method of claim 1, further comprising:
receiving, by the system, work environment information relating to a work environment associated with the group of tasks or the user identity, wherein the analyzing comprises analyzing the task-related information, the assessment information, the biometric information, and the work environment information, and
wherein the adaptively adjusting comprises adaptively adjusting the respective attributes of the respective tasks based on the result of the analyzing of the task-related information, the assessment information, the biometric information, and the work environment information.

13. A system, comprising:
a processor; and
a memory that stores executable instructions that, when executed by the processor, facilitate performance of operations, comprising:
analyzing task-related data relating to a group of tasks associated with a user identity, assessment data relating to assessing performance of a task, and biometric data relating to health, diet, and activity associated with the user identity;
adaptively modifying respective elements associated with respective tasks of the group of tasks based on a result of the analyzing of the task-related data, the assessment data, and the biometric data; and
communicating task data to user equipment associated with the user identity to facilitate performance of the group of tasks, wherein the task data relates to, and is determined based on, the adaptively modifying of the respective elements associated with the respective tasks.

14. The system of claim 13, wherein the group of tasks comprises the task, and wherein the adaptively modifying comprises:
adaptively re-arranging a first order of performance of remaining tasks of the group of tasks to generate a second order of performance of the remaining tasks;
adaptively modifying respective scheduling of the performance of the remaining tasks;
adaptively modifying a priority level associated with the task;
adaptively modifying an amount of time allocated to perform the task;
adaptively modifying instructions relating to performance of the task;
adaptively modifying a determination relating to an amount of progress that has been made towards completion of the task or the group of tasks;
adaptively modifying a reminder, notification, or motivation message associated with the task;
adaptively modifying calendar data in an electronic calendar, wherein the calendar data is associated with the task; or
adaptively modifying reward data relating to a reward that is able to be presented in connection with completion of the task or the group of tasks.

15. The system of claim 13, wherein the operations further comprise:
based on the analyzing, determining a group of sub-tasks of the task, a sequence of performance of the sub-tasks of the group of sub-tasks, or respective amounts of time to allocate for the performance of the sub-tasks.

16. The system of claim 13, wherein the operations further comprise:
determining a sequence of sub-tasks of the task and instructions for performing the sequence of the sub-tasks that satisfy a defined task performance efficiency criterion based on analysis of feedback data and the defined task performance efficiency criterion,
wherein the feedback data relates to previous performance of a previous task that is determined to be same as or relevant with respect to the task or is determined to satisfy a defined task similarity criterion with respect to the task,
wherein the feedback data is received from devices associated with user identities, and
wherein the communicating of the task data comprises communicating instruction data relating to the instructions for performing the sequence of the sub-tasks to the user equipment to facilitate performance of the task in accordance with the instructions.

17. The system of claim 13, wherein the communicating of the task data comprises communicating recommendation data that recommends a schedule for performance of the respective tasks based on a performance metric associated with the respective tasks, and wherein the operations further comprise:
receiving feedback data associated with the user identity, wherein the feedback data comprises a request to modify the schedule; and
determining whether to modify the schedule based on a determination regarding whether implementation of the modification to the schedule is able to satisfy the performance metric.

18. The system of claim 17, wherein the receiving of the feedback data comprises receiving the feedback data via a virtual assistant device of or associated with the user equipment, and wherein the operations further comprise:
determining a personality attribute of a virtualized personality of the virtual assistant device based on sensor data of a sensor associated with the user identity, the feedback data associated with the user identity, or a context of an interaction between the virtual assistant device and a user associated with the user identity, wherein the personality attribute is determined to enhance a negotiation with the user with regard to the request to modify the schedule;
applying the personality attribute of the virtualized personality to the virtual assistant device during the interaction; and
communicating, via the virtual assistant device, negotiation data to the user to facilitate negotiation with the user with regard to the request to modify the schedule to facilitate the determining of whether to modify the schedule.

19. A non-transitory machine-readable medium, comprising executable instructions that, when executed by a processor, facilitate performance of operations, comprising:
evaluating task-related information relating to a group of tasks associated with a user identity, assessment information relating to assessing performance of a task, and biometric information relating to health, diet, and activity associated with the user identity;
adaptively altering respective properties associated with respective tasks of the group of tasks based on a result of the evaluating of the task-related information, the assessment information, and the biometric information, the adaptively altering resulting in respective altered properties associated with the respective tasks; and
communicating task information to a device associated with the user identity to facilitate performance of the group of tasks, wherein the task information is determined based on the respective altered properties.

20. The non-transitory machine-readable medium of claim 19, wherein the group of tasks comprises the task, and wherein the adaptively altering comprises adaptively altering an order, a sequence, or a schedule of the performance of the respective tasks, adaptively altering an amount of time allocated to perform the task, adaptively altering a priority level associated with the task, adaptively altering a determination regarding an amount of progress that has been made towards completion of the task, adaptively altering instructions relating to performance of the task, adaptively altering a reminder, notification, or motivation message relating to the task, adaptively altering calendar information relating to the task in an electronic calendar, or adaptively altering a reward that is to be presented in connection with completion of the task or the group of tasks.
